(19) United States
(12) Patent Application Publication
(10) Pub. No.: US 2013/0128339 A1
(43) Pub. Date: May 23, 2013

(54) PHOTOREFRACTIVE COMPOSITION RESPONSIVE TO MULTIPLE LASER WAVELENGTHS ACROSS THE VISIBLE LIGHT SPECTRUM

(71) Applicants: Tao Gu, San Diego, CA (US); Mohanalingam Kathaperumal, Oceanside, CA (US); Rachwal Bogumila, Irvine, CA (US); Joshua Tillema, Oceanside, CA (US); Ozair Siddiqui, Murrieta, CA (US); Peng Wang, San Diego, CA (US); Weiping Lin, Carlsbad, CA (US); Donald Flores, San Diego, CA (US); Zongcheng Jiang, Oceanside, CA (US); Shijun Zheng, San Diego, CA (US); Michiharu Yamamoto, Carlsbad, CA (US)

(72) Inventors: Tao Gu, San Diego, CA (US); Mohanalingam Kathaperumal, Oceanside, CA (US); Rachwal Bogumila, Irvine, CA (US); Joshua Tillema, Oceanside, CA (US); Ozair Siddiqui, Murrieta, CA (US); Peng Wang, San Diego, CA (US); Weiping Lin, Carlsbad, CA (US); Donald Flores, San Diego, CA (US); Zongcheng Jiang, Oceanside, CA (US); Shijun Zheng, San Diego, CA (US); Michiharu Yamamoto, Carlsbad, CA (US)

(73) Assignee: NITTO DENKO CORPORATION, OSAKA (JP)

(21) Appl. No.: 13/814,201

(22) PCT Filed: Aug. 5, 2010
(86) PCT No.: PCT/US10/44610

§ 371 Date: Feb. 4, 2013

(51) Int. Cl. G02F 1/00; G02F 1/29

(52) U.S. Cl. CPC G02F 1/0063; G02F 1/293; Y10S 977/734; Y10S 977/75; B82B 1/008
USPC 359/299; 252/582; 977/734; 977/750

(57) ABSTRACT

Described herein are compositions that are photorefractive upon irradiation by multiple laser wavelengths across the visible light spectrum. Embodiments of the photorefractive composition comprise a polymer, a chromophore, and a sensitizer, wherein the polymer comprises a repeating unit including at least a moiety selected from the group consisting of the formulae (Ia), (Ib) and (Ic), as defined herein. The photorefractive composition can be used in optical devices.

### BACKGROUND OF THE INVENTION

1. Field of the Invention

The invention relates to a photorefractive composition comprising a chromophore and a polymer, such that the composition is configured to be photorefractive upon irradiation by multiple wavelengths of laser light across the visible light spectrum. For example, the photorefractive composition can be irradiated with light from two or more lasers selected from a blue laser, a green laser, and a red laser. More particularly, the polymer comprises one or more repeating units that include a moiety selected from a carbazole moiety, a tetraphenyl diaminobiphenyl moiety, and a triphenylamine moiety. The composition may include a sensitizer, which can provide a desired absorption coefficiency at the working wavelength. The compositions described herein can be used for various purposes such as holographic data storage (1, 2 and 3-dimensional), image recording materials (1, 2 and 3-dimensional), and/or related devices.

2. Description of the Related Art

Photorefractivity is a phenomenon in which the refractive index of a material can be altered by changing the electric field within the material, such as by laser beam irradiation. The change of the refractive index typically involves: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) a refractive index change induced by the non-uniform electric field. Good photorefractive properties are typically observed in materials that combine good charge generation, charge transport or photoconductivity and electro-optical activity. Photorefractive materials have many promising applications, such as high-density optical data storage, dynamic holography, optical image processing, phase conjugated mirrors, optical computing, parallel optical logic, and pattern recognition. Particularly, long lasting grating behavior can contribute significantly for high-density optical data storage or holographic display applications.

Originally, the photorefractive effect was found in a variety of inorganic electro-optical (EO) crystals, such as LiNbO₃. In these materials, the mechanism of a refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264, the contents of which are hereby incorporated by reference in their entirety. Organic photorefractive materials offer many advantages over the original inorganic photorefractive crystals, such as large optical nonlinearities, low dielectric constants, low cost, lightweight, structural flexibility, and ease of device fabrication. Other advantageous characteristics that may be desirable depending on the application include sufficiently long shelf life, optical quality, and thermal stability. These kinds of active organic polymers are emerging as key materials for advanced information and telecommunication technology.

In recent years, efforts have been made to improve the properties of organic, and particularly polymeric, photorefractive materials. Various studies have been done to examine the selection and combination of the components that give rise to each of these features. Photoconductive capability can be provided by incorporating materials containing carbazole groups. Phenyl amine groups can also be used for the charge transport part of the material.

The photorefractive composition may be made by mixing molecular components that provide desirable individual properties into a host polymer matrix. However, many of the previously prepared compositions failed to show good photorefractivity performances, (e.g., high diffraction efficiency, fast response time and long-term stability). Efforts have been made, therefore, to provide compositions which show high diffraction efficiency, fast response time and long stability.

U.S. Pat. Nos. 6,653,421 and 6,610,809, the contents of which are both hereby incorporated by reference in their entireties, disclose compositions comprising (meth)acrylate-based polymers and copolymers that exhibit high diffraction efficiency, fast response time, and long-term phase stability. The materials, which are configured to be photorefractive upon irradiation with a red laser, show fast response times of less than 30 msec and diffraction efficiency of higher than 50%, along with no phase separation for at least two or three months. U.S. Patent Application Publication Nos. 2008/0039603 and 2009/0052009, the contents of which are both hereby incorporated by reference in their entireties, disclose photorefractive compositions that also exhibit useful properties, which are configured to be photorefractive upon irradiation with a green laser. U.S. Patent Application Publication No. 2009/0197186, the contents of which are hereby incorporated by reference in its entirety, discloses photorefractive compositions that also exhibit useful properties, which are configured to be photorefractive upon irradiation with a blue laser. In an embodiment, the photorefractive composition of U.S. Patent Application Publication No. 2009/0197186 comprises the chromophore PNO2:

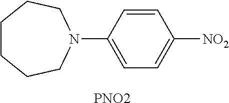

U.S. Patent Application Publication No. 2004/0043301, the contents of which are hereby incorporated by reference in its entirety, discloses a data storage medium comprising a recording layer containing molecules having charge transport characteristics, molecules having nonlinear optical characteristics, and optical functional molecules whose stereostructure can be changed depending on light irradiation. The conductivity of the data storage medium is lowered by light irradiation. However, the diffraction efficiency immediately after the recording was found to be too low (˜1.0%) for practical application in commercial devices.

### SUMMARY OF THE INVENTION

There remains a need for photorefractive compositions that combine various of the above-mentioned attributes and that are configured to be photorefractive upon irradiation with more than one laser wavelength. There is particularly a need for a composition that can be configured to be photorefractive upon irradiation with two or more of a red laser, a green laser, and/or a blue laser. There also remains a need to provide novel photorefractive compositions comprising a polymer and a chromophore. Embodiments provide compositions and methods of using the photorefractive compositions described herein, where grating signals can be written and held after several minutes, or longer, for data or image storage purposes. Embodiments of the organic based materials and holographic medium developed by the inventors show fast response times and good diffraction efficiencies to multiple light wavelengths across the visible spectrum. Furthermore, grating signals can also be rewritten into the preferred compositions after initial exposure to laser light. The availability of such materials that are sensitive to red, green, and/or blue color continuous wave (CW) laser system can be greatly advantageous and useful for industrial application purpose and image storage purposes.

Some embodiments of this invention provide a composition configured to be photorefractive upon irradiation by at least a first laser having a first wavelength in the visible light spectrum and a second laser having a second wavelength in the visible light spectrum, wherein the photorefractive composition comprises a hole-transfer type polymer which exhibits fast response time, high diffraction efficiency, and good phase stability. More specifically, the polymer may comprise at least a repeating unit including a moiety selected from the group consisting of the carbazole moiety, tetraphenyl diaminobiphenyl moiety, and triphenylamine moiety. In some embodiment, the composition can be used for holographic data storage, as image recording materials, and in optical devices.

In an embodiment, a photorefractive composition is provided that comprises a polymer a chromophore, wherein the polymer comprises a repeating unit that includes at least one moiety selected from the group consisting of the following formulae (Ia), (Ib) and (Ic):

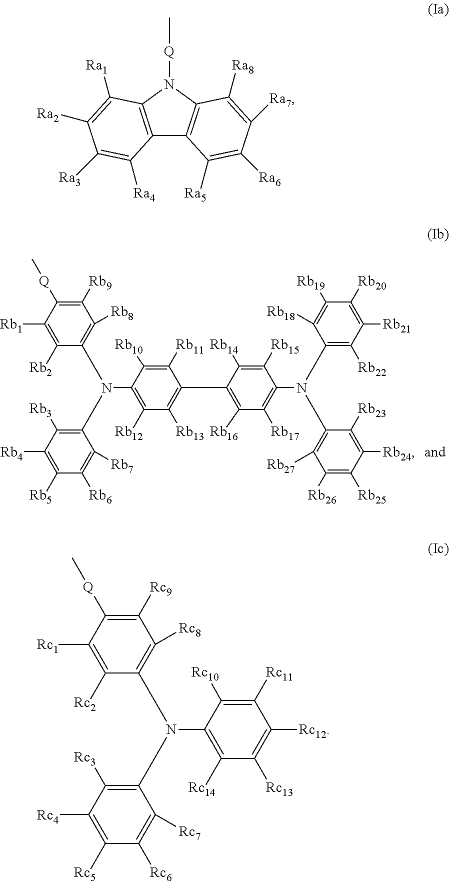

In an embodiment, each Q in formulae (Ia), (Ib) and (Ic) independently represents an alkylene group having from 1 to 10 carbon atoms or a heteroalkylene group having from 1 to 10 carbon atoms, Ra₁-Ra₈, Rb₁-Rb₂₇ and Rc₁-Rc₁₄ in (Ia), (Ib), and (Ic) are each independently selected from the group consisting of hydrogen, C₁-C₁₀ alkyl, and C₄-C₁₀ aryl, wherein the C₁-C₁₀ alkyl may be linear or branched. The heteroalkylene group can comprise one or more heteroatoms. Any heteroatom or combination of heteroatoms can be used, including O, N, S, and any combination thereof. In an embodiment, the photorefractive composition is configured to be photorefractive upon irradiation by at least a first laser having a first wavelength in the visible light spectrum and a second laser having a second wavelength in the visible light spectrum. For example, the polymer and the chromophore can be together selected to configure the composition to be photorefractive upon irradiation by the first laser and the second laser. In an embodiment, the photorefractive composition further comprises a sensitizer. In an embodiment, the first laser is selected from the group consisting of a blue laser, a green laser, and a red laser. In an embodiment, the second laser is different than the first laser, and is selected from the group consisting of a blue laser, a green laser, and a red laser.

The composition can be configured to be photorefractive upon irradiation with a third laser having a third wavelength in the visible light spectrum, such that the third laser is different from the first laser and the second laser, wherein the third laser is selected from a blue laser, a green laser, and a red laser. In an embodiment, the composition is configured to be photorefractive by each of a blue laser, a green laser, and a red laser. For example, the composition can be configured to be photorefractive upon irradiation with a red laser, a green laser, and/or a blue laser, by the selection and incorporation of appropriate chromophore and polymer. In an embodiment, the composition is configured to be photorefractive upon irradiation with a red laser, a green laser, and a blue laser, by the selection and incorporation of appropriate chromophore, sensitizer, and polymer.

The chromophore can be added into the composition as a mixture with the polymer and/or be directly bonded to the polymer, e.g., by covalent or other bonding. In some embodiments, the chromophore comprises an electron donating group, a π-conjugating group, and an electron acceptor group.

In an embodiment, the sensitizer comprises a fullerene. In some embodiments, the fullerene is selected from the group consisting of optionally substituted C₆₀, optionally substituted C₇₀, optionally substituted C₈₄, optionally substituted single-wall carbon nanotube, and optionally substituted multi-wall carbon nanotube. In some embodiments, the fullerene is selected from the group consisting of soluble C₆₀ derivative [6,6]-phenyl-C₆₁-butyricacid-methylester, soluble C₇₀ derivative [6,6]-phenyl-C₇₁-butyricacid-methylester, and soluble C₈₄ derivative [6,6]-phenyl-C₈₅-butyricacid-methylester.

Another embodiment provides a method for modulating light comprising the steps of providing a photorefractive composition that comprises a polymer and a chromophore, wherein the polymer comprises a repeating unit that includes a moiety selected from the group consisting of (Ia), (Ib), and (Ic) as described above, and irradiating the photorefractive composition with two or more of a blue laser, a green laser and a red laser to thereby modulate a photorefractive property of the composition. In an embodiment, the photorefractive composition further comprises a sensitizer.

The compositions described herein have great utility in a variety of optical applications, including holographic storage, optical correlation, phase conjugation, non-destructive evaluation, and imaging.

These and other embodiments are described in greater detail below.

### BRIEF DESCRIPTION OF THE DRAWINGS

FIG. 1 is a schematic depiction illustrating a hologram recording system with a photorefractive composition.

FIGS. 2A and 2B provide chemical structures for exemplary chromophores according to the general formula (VII).

FIG. 3 provides chemical structures for exemplary chromophores according to the general formula (VIII).

### DETAILED DESCRIPTION OF THE INVENTION

Described herein are compositions that respond favorably upon irradiation with light in more than one of a red wavelength, a green wavelength, and a blue wavelength. In an embodiment, the photorefractive compositions have chemical and optical properties that are compatible with the transmittance of all three wavelengths of color light. As described herein, a laser having a blue wavelength is as a laser having a wavelength in the range of about 400 nm to about 490 nm. In an embodiment, the blue laser has a wavelength of about 488 nm. In an embodiment, the blue laser has a wavelength of about 457 nm. As described herein, a laser having a green wavelength is as a laser having a wavelength in the range of about 490 nm to about 600 nm. In an embodiment, the green laser has a wavelength of about 532 nm. As described herein, a laser having a red wavelength is as a laser having a wavelength in the range of about 600 nm to about 700 nm. In an embodiment, the red laser has a wavelength of about 633 nm.

Some embodiments provide an optical device comprising a photorefractive composition as described herein. In an embodiment, the optical device is responsive to irradiation by at least two of a blue laser, a green laser, and a red laser. In some embodiments, the composition can be made photorefractive upon irradiation by continuous wave (CW) lasers.

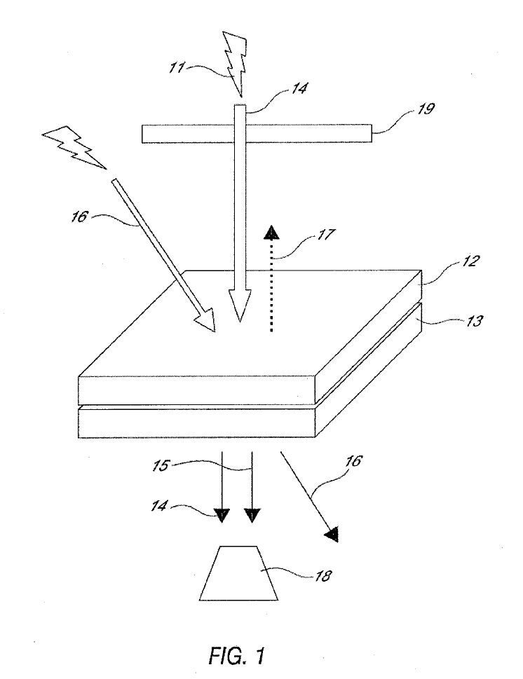

FIG. 1 is a schematic depiction illustrating a non-limiting embodiment of a hologram recording system with a photorefractive composition. Information may be recorded into the hologram medium, and the recorded information may be read out simultaneously. A laser source 11 may be used as to write information onto a recording medium 12. The recording medium 12 comprises a photorefractive composition as described herein and is positioned over a support material 13.

Laser beam irradiation of object beam 14 and reference beam 16 into the recording medium 12 causes interference grating, which generates internal electric fields and a refractive index change. Object beam 14 and reference beam 16 can project from various sides of the device other than those illustrated in FIG. 1. For example, instead of projecting from the same side of the recording medium 12, object beam 14 and reference beam 16 could project from opposite sides of the recording medium 12. Any type of angle between the object beam 14 and reference beam 16 can also be used. Multiple recordings are possible in the photorefractive composition of the recording medium 12 by changing the angle of the incident beam. The object beam 14 has a transmitted portion 15 of the beam and a refracted portion 17 of the beam.

An image display device 19 is set up parallel to the X-Y plane of the recording medium 12. Various types of image display devices may be employed. Some non-limiting examples of image display devices include a liquid crystal device, a Pockels Readout Optical Modulator, a Multichannel Spatial Modulator, a CCD liquid crystal device, an AO or EO modulation device, or an opto-magnetic device. On the other side of the recording medium 12, a read-out device 18 is also set up parallel to the X-Y plane of the recording medium 12. Suitable read-out devices include any kind of opto-electro converting devices, such as CCD, photo diode, photoreceptor, or photo multiplier tube.

In order to read out recorded information, the object beam 14 is shut out and only the reference beam 16, which is used for recording, is irradiated. A reconstructed image may be restored, and the reading device 18 is installed in the same direction as the transmitted portion 15 of the object beam and away from the reference beam 16. However, the position of the reading device 18 is not restricted to the positioning shown in FIG. 1. Recorded information in the photorefractive composition can be erased completely by whole surface light irradiation, or partially erased by laser beam irradiation.

The method can build the diffraction grating on the recording medium. This hologram device can be used not only for optical memory devices but also other applications, such as a hologram interferometer, a 3D holographic display, coherent image amplification applications, novelty filtering, self-phase conjugation, beam fanning limiter, signal processing, and image correlation, etc.

For the photorefractive device according to the invention, usually the thickness of a photorefractive layer is from about 10 μm to about 200 μm. Preferably, the thickness range is from about 30 μm to about 150 μm. If the sample thickness is less than 10 μm, the diffracted signal is typically not in the desired Bragg Refraction region, but Raman-Nathan Region which does not show proper grating behavior. On the other hand, if the sample thickness is greater than 200 μm, too high biased voltage would typically be required to show grating behavior. Also, the transmittance for all color laser beams in overly thick photorefractive layers can be reduced significantly and result in no grating signals.

In some embodiments, the polymer comprises a repeating unit that includes at least one moiety selected from the group consisting of a carbazole moiety (represented by formula (Ia), above), a tetraphenyl diaminobiphenyl moiety (represented by the formula (Ib), above), and a triphenylamine moiety (represented by the formula (Ic), above).

In some embodiments, at least one recurring unit of formulae (Ia), (Ib) and (Ic) may be incorporated to form a charge transport component of a photorefractive polymer. In some embodiments, for example, the polymer can be a homopolymer of a desired recurring unit, each of which comprises a charge transport moiety. In some embodiments, for example, two or more recurring units comprising different charge transport moieties may be included to form a photorefractive copolymer. The polymer formed by inclusion of these moieties has charge transport ability. Those skilled in the art will appreciate that the use of the term “polymer” herein includes copolymers.

Each of the moieties of formulae (Ia), (Ib), and (Ic) can be attached to a polymer backbone. Many polymer backbone, including but not limited to, polyurethane, epoxy polymers, polystyrene, polyether, polyester, polyamide, polyimide, polysiloxane, and polyacrylate, with the appropriate side chains attached, can be used to make the polymers of the photorefractive compositions. Some embodiments contain backbone units based on acrylates or styrene, and some of preferred backbone units are formed from acrylate-based monomers, and some are formed from methacrylate monomers. It is believed that the first polymeric materials to include photoconductive functionality in the polymer itself were the polyvinyl carbazole materials developed at the University of Arizona. However, these polyvinyl carbazole polymers tend to become viscous when subjected to the heat-processing methods typically used to form the polymer into films or other shapes for use in photorefractive devices.

The (meth)acrylate-based and acrylate-based polymers used in embodiments described herein exhibit good thermal and mechanical properties. Such polymers provide improved durability and workability during processing by injection-molding or extrusion, especially when the polymers are prepared by radical polymerization. Some embodiments provide a composition comprising a photorefractive polymer that is activated upon irradiation by two or more of a red laser, a green laser, and a blue laser, wherein the photorefractive polymer comprises a repeating unit selected from the group consisting of the following formulae (Ia′), (Ib′) and (Ic′):

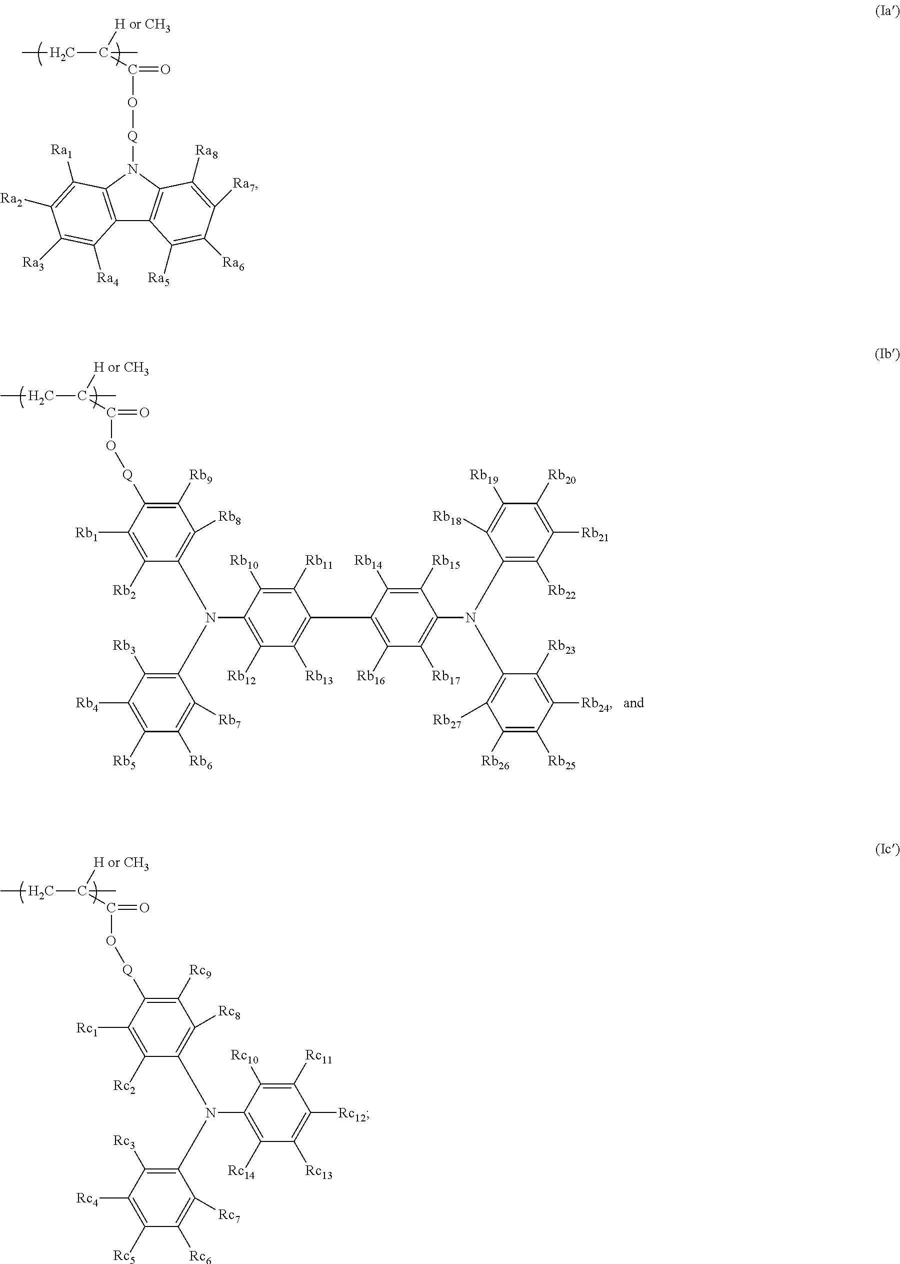

wherein each Q, Ra₁-Ra₈, Rb₁-Rb₂₇ and Rc₁-Rc₁₄ in formulae (Ia′), (Ib′) and (Ic′) is as defined above in formulae (Ia), (Ib), and (Ic).

In some embodiments, a polymer comprising at least one repeating unit of formulae (Ia′), (Ib′) or (Ic′) can be formed by copolymerization of the corresponding monomers to provide a photorefractive polymer that provides charge transport ability. In some embodiments, monomers comprising a phenyl amine derivative can be copolymerized to form the charge transport component as well. Non-limiting examples of such monomers are carbazolylpropyl (meth)acrylate monomer; 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. These monomers can be used singly or in combination to provide homopolymers or copolymers.

The photorefractive composition can comprise a chromophore. In an embodiment, the chromophore provides additional non-linear optical functionality. In an embodiment, the chromophore is a molecule that contains an electron donor group, an electron acceptor group, and a π-conjugated group connecting the electron donor and the electron acceptor groups. In some embodiments, the chromophore can be attached to the polymer backbone in one or more side chains. In some embodiments, the chromophore can be incorporated into the photorefractive composition as a separate compound.

In some embodiments, the photorefractive composition may comprise a polymer having one or more non-linear optical moiety. In some embodiments, the non-linear optical moiety may be present as a side chain on the polymer backbone, created by copolymerization with monomers having the charge transport moieties. In some embodiments, the polymers described herein further comprise a second repeating unit represented by the following formula (IIa):

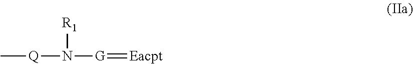

wherein Q in formula (IIa), independently of Q in formulae (Ia), (Ib), and (Ic), represents an alkylene group having from 1 to 10 carbon atoms or a heteroalkylene group having from 1 to 10 carbon atoms, the heteroalkylene group has one or more heteroatoms selected from S or O; R₁ in formula (IIa) is selected from the group consisting of hydrogen, linear and branched C₁-C₁₀ alkyl, and C₄-C₁₀ aryl; G in formula (IIa) is a π-conjugated group; and Eacpt in formula (IIa) is an electron acceptor group. In some embodiments, R₁ in formula (IIa) is an alkyl group selected from methyl, ethyl, propyl, butyl, pentyl and hexyl. In some embodiments, Q in formula (IIa) is an alkylene group represented by (CH₂)ₚ where p is from about 2 to about 6. In some embodiments, Q in formula (IIa) is selected from the group consisting of ethylene, propylene, butylene, pentylene, hexylene, and heptylene.

In some embodiments, the polymer comprises a repeating unit represented by the following formula (IIa′):

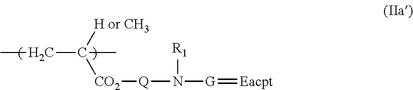

wherein Q, R₁, G, and Eacpt in formula (IIa′) have the meanings set forth above in formula (IIa). In some embodiments, R₁ in formula (IIa′) is an alkyl group selected from methyl, ethyl, propyl, butyl, pentyl and hexyl. In some embodiments, Q in formula (IIa′) is an alkylene group represented by (CH₂)ₚ where p is from about 2 to about 6. In some embodiments, Q in formula (IIa′) is selected from the group consisting of ethylene, propylene, butylene, pentylene, hexylene, and heptylene.

The term “π-conjugated group” refers to a molecular fragment that contains π-conjugated bonds. The π-conjugated bonds refer to covalent bonds between atoms that have σ bonds and π bonds formed between two atoms by overlapping of atomic orbits (s+p hybrid atomic orbits for σ bonds and p atomic orbits for π bonds). In some embodiments, G in formulae (IIa) and (IIa′) is independently represented by a formula selected from the following:

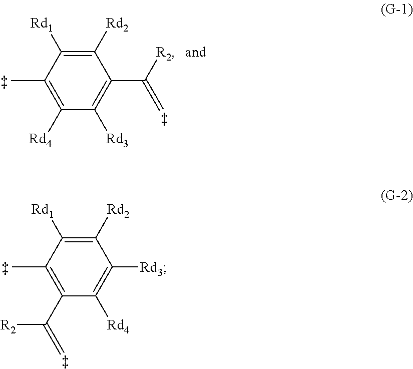

wherein Rd₁-Rd₄ in (G-1) and (G-2) are each independently selected from the group consisting of hydrogen, linear and branched C₁-C₁₀ alkyl, C₄-C₁₀ aryl, and halogen and R₂ in (G-1) and (G-2) is independently selected from the group consisting of hydrogen, linear and branched C₁-C₁₀ alkyl, and C₄-C₁₀ aryl.

The term “electron acceptor group” refers to a group of atoms with a high electron affinity that can be bonded to a π-conjugated group. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein each R in these electron acceptors may independently be, for example, hydrogen, linear and branched C₁-C₁₀ alkyl, and C₄-C₁₀ aryl. As shown in U.S. Pat. No. 6,267,913, examples of electron acceptor groups include:

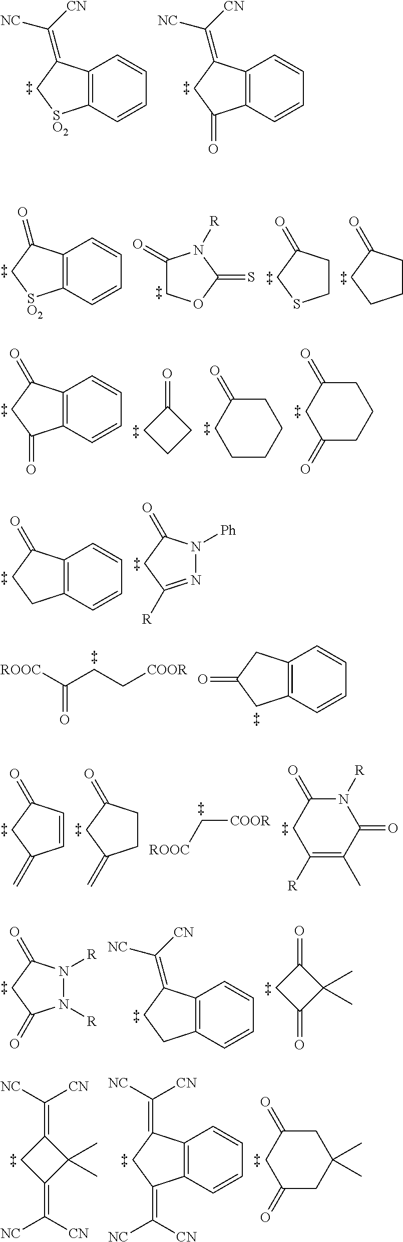

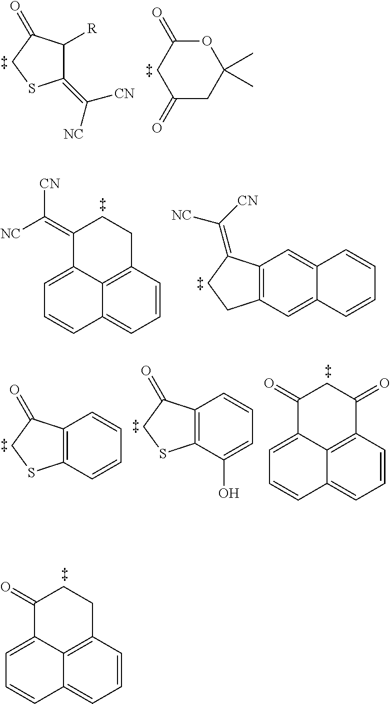

wherein R is selected from the group consisting of hydrogen, linear and branched C₁-C₁₀ alkyl, and C₄-C₁₀ aryl. The symbol “‡” in a chemical structure specifies an atom of attachment to another chemical group and indicates that the structure is missing a hydrogen that would normally be implied by the structure in the absence of the “‡”

In some embodiments, Eacpt in formulae (IIa) and (IIa′) is ═O or represented by a structure selected from the group consisting of the following formulae:

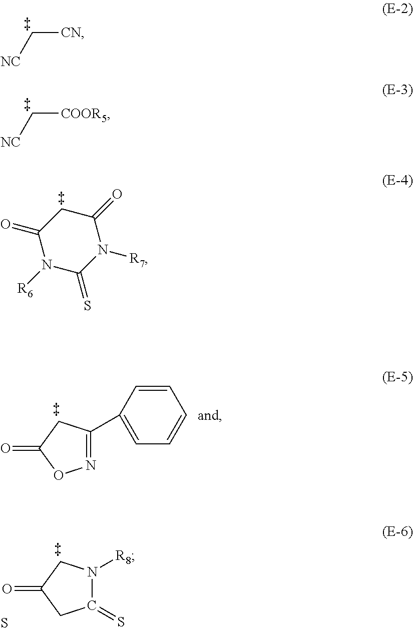

wherein R₅, R₆, R₇ and R₈ in formulae (E-3), (E-4) and (E-6) are each independently selected from the group consisting of hydrogen, linear and branched C₁-C₁₀ alkyl, and C₄-C₁₀ aryl.

To prepare the non-linear optical component containing copolymer, monomers that have side-chain groups possessing non-linear-optical ability may be used. Non-limiting examples of such monomers include formulae (IIa′-1), (IIa′-2), and (IIa′-3):

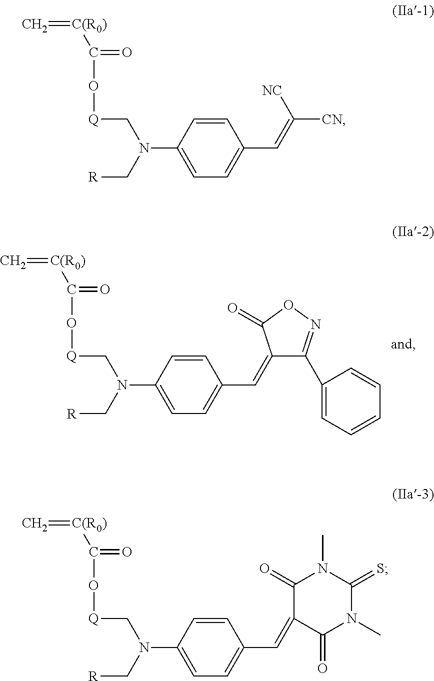

wherein each Q in the formulae (IIa′-1), (IIa′-2), and (IIa′-3) independently represent an alkylene group having from 1 to 10 carbon atoms or a heteroalkylene group having from 1 to 10 carbon atoms, the heteroalkylene group has one or more heteroatoms such as O and S; each R₀ in the monomers above is independently selected from hydrogen or methyl; and each R in the monomers above is independently selected from linear and branched C₁-C₁₀ alkyl. In some embodiments, Q in the formulae (IIa′-1), (IIa′-2), and (IIa′-3) may be an alkylene group represented by —(CH₂)ₚ— where p is an integer in the range of about 2 to about 6. In some embodiments, each R in the monomers above may be independently selected from the group consisting methyl, ethyl and propyl. Each R₀ in the monomers above may be independently H or CH₃.

The polymers described herein may be prepared in various ways, e.g., by polymerization of the corresponding monomers or precursors thereof. Polymerization may be carried out by methods known to a skilled artisan, as informed by the guidance provided herein. In some embodiments, radical polymerization using an azo-type initiator, such as AIBN (azoisobutyl nitrile), may be carried out. The radical polymerization technique makes it possible to prepare random or block copolymers comprising both charge transport and non-linear optical groups. Further, by following the techniques described herein, it is possible in preferred embodiments to prepare such materials with exceptionally good properties, such as photoconductivity, response time and diffraction efficiency. In an embodiment of a radical polymerization method, the polymerization catalysis is generally used in an amount of from 0.01 to 5 mole % or from 0.1 to 1 mole % per mole of the total polymerizable monomers.

In some embodiments, radical polymerization can be carried out under inert gas (e.g., nitrogen, argon, or helium) and/or in the presence of a solvent (e.g., ethyl acetate, tetrahydrofuran, butyl acetate, toluene or xylene). Polymerization may be carried out under a pressure from 1 to 50 Kgf/cm² or from 1 to 5 Kgf/cm². In some embodiments, the concentration of total polymerizable monomer in a solvent may be about 0.99% to about 50% by weight based on the total weight of the composition, preferably about 2% to about 9.1% by weight based on the total weight of the composition. The polymerization may be carried out at a temperature of about 50° C. to about 100° C., and may be allowed to continue for about 1 to about 100 hours, depending on the desired final molecular weight, polymerization temperature, and taking into account the polymerization rate.

Some embodiments provide a polymerization method involving the use of a precursor monomer with a functional group for non-linear optical ability for preparing the copolymers. The precursor may be represented by the following formula:

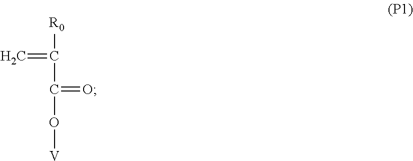

wherein R₀ in (P1) is hydrogen or methyl, and V in (P1) is a group selected from the formulae (V-1) and (V-2):

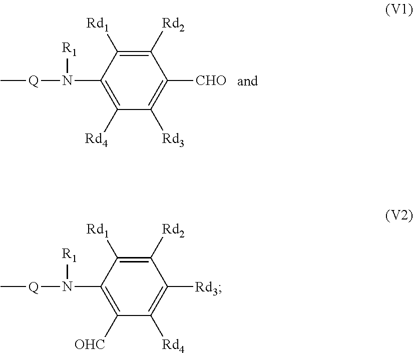

wherein each Q in (V1) and (V2), independently of other Q groups in other moieties, independently represents an alkylene group having from 1 to 10 carbon atoms or a heteroalkylene group having from 1 to 10 carbon atoms, the heteroalkylene group has one or more heteroatoms such as O and S; Rd₁-Rd₄ in (V1) and (V2) are each independently selected from the group consisting of hydrogen, linear and branched C₁-C₁₀ alkyl, C₄-C₁₀ aryl, and R₁ in (V1) and (V2) is C₁-C₁₀ alkyl (branched or linear). In some embodiments, Q in (V1) and (V2) may independently be an alkylene group represented by —(CH₂)ₚ— where p is an integer in the range of about 2 to about 6. In some embodiments, R₁ in (V1) and (V2) is independently selected from a group consisting of methyl, ethyl, propyl, butyl, pentyl and hexyl. In an embodiment, Rd₁-Rd₄ in (V1) and (V2) are hydrogen.

In some embodiments, the polymerization method works under the same initial operating conditions as described above, and it also follows the same procedure to form the precursor polymer. After the precursor copolymer has been formed, it can be converted into the corresponding copolymer having non-linear optical groups and capabilities by a condensation reaction. In some embodiments, the condensation reagent may be selected from the group consisting of:

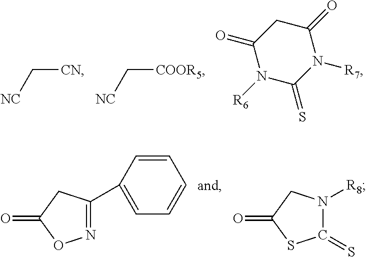

wherein R₅, R₆, R₇ and R₈ of the condensation reagents above are each independently selected from the group consisting of hydrogen, C₁-C₁₀ alkyl and C₄-C₁₀ aryl. The alkyl group may be either branched or linear.

In some embodiments, the condensation reaction can be carried out in the presence of a pyridine derivative catalyst at room temperature for about 1 to about 100 hours. In some embodiments, a solvent, such as butyl acetate, chloroform, dichloromethane, toluene or xylene, can also be used. In some embodiments, the reaction may be carried out without the catalyst at a solvent reflux temperature of 30° C. or above for about 1 to about 100 hours.

Other ingredients that possess non-linear optical properties upon incorporation into a polymer matrix are described in U.S. Pat. No. 5,064,264 (incorporated herein by reference) and may also be used in some embodiments. Additional suitable materials known in the art may also be used, and are well described in the literature, such as D. S. Chemla & J. Zyss, “Nonlinear Optical Properties of Organic Molecules and Crystals” (Academic Press, 1987). U.S. Pat. No. 6,090,332 describes fused ring bridge and ring locked chromophores that can form thermally stable photorefractive compositions, which may be useful as well. The chosen compound(s) is sometimes mixed in the copolymer in a concentration in the range of about 1% to about 50% by weight based on the total weight of the composition.

In some embodiments, monomers comprising a non-linear optical moiety, can also be used to prepare the non-linear optical component-containing polymer. Non-limiting examples of monomers including a non-linear optical moiety group include N-ethyl, N-4-dicyanomethylidenyl acrylate and N-ethyl, N-4-dicyanomethylidenyl-3,4,5,6,10-pentahydronaphtylpentyl acrylate. Alternatively, or additionally, the non-linear functionality can be added to the composition as a separate ingredient that is not copolymerized with the charge-transport monomers.

In an embodiment, the photorefractive composition comprises a chromophore that, in combination with the other components of the composition, configures the composition to be sensitive to two or more wavelengths of visible light lasers, e.g., blue, green, and red lasers. In an embodiment, the photorefractive composition can be configured to be sensitive to two or more wavelengths of laser by selection of the type and amount of polymer and to render the composition sensitive to the selected laser wavelengths. In an embodiment, the photorefractive composition may further comprise a type and amount of sensitizer selected to render the composition sensitive to one or more visible light wavelengths. Various chromophores can be used in the photorefractive compositions to obtain such a composition. In some embodiments, the chromophore is represented by formula (III):

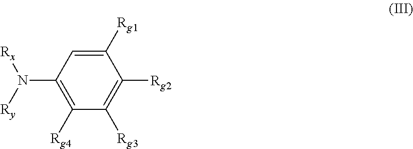

wherein Rₓ and R_{y} in formula (III) together with the nitrogen to which they are attached form a cyclic C₄-C₉ ring or Rₓ and R_{y} in formula (III) are each independently selected from a C₁-C₆ alkyl group or a C₄-C₁₀ aryl group; R_{g1}-R_{g4} in formula (III) are each independently selected from hydrogen or CN; and at least one of R_{g1}-R_{g4} in formula (III) is CN. In an embodiment, at least two of R_{g1}-R_{g4} in formula (III) are CN. In an embodiment, Rₓ and R_{y} in formula (III) together with the nitrogen to which they are attached form a cyclic C₅-C₈ ring.

In some embodiments, the chromophore of formula (III) is represented by formula (IIIa):

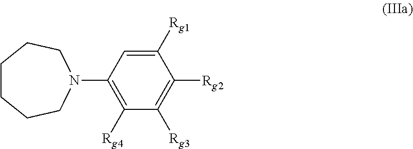

wherein R_{g1}-R₀ in formula (IIIa) are each independently selected from hydrogen or CN, and at least one of R_{g1}-R₀ in formula (IIIa) is CN. In an embodiment, at least two of R_{g1}-R₀ in formula (IIIa) are CN. In an embodiment, the chromophore of formula (IIIa) is selected from one of the following compounds.

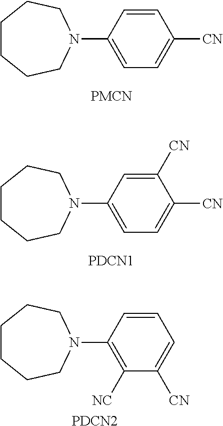

In some embodiments, the chromophore is represented by formula (IV):

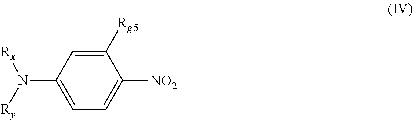

wherein Rₓ and R_{y} in formula (IV) together with the nitrogen to which they are attached form a cyclic C₄-C₉ ring or Rₓ and R_{y} in formula (IV) are each independently selected from a C₁-C₆ alkyl group or a C₄-C₁₀ aryl group; and R_{g5} in formula (IV) is C₁-C₆ alkyl. In an embodiment, Rₓ and R_{y} in formula (IV) together with the nitrogen to which they are attached form a cyclic C₅-C₈ ring.

In some embodiments, the chromophore of formula (IV) is represented by formula (IVa):

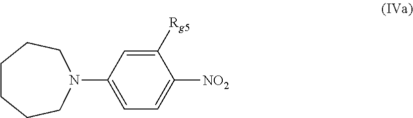

wherein R_{g5} in formula (IVa) is C₁-C₆ alkyl. In an embodiment, the chromophore of formula (IVa) is the following compound.

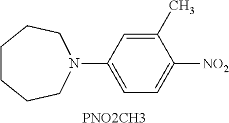

In some embodiments, the chromophore is represented by formula (V):

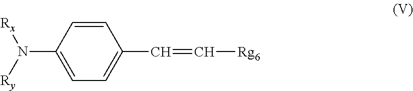

wherein Rₓ and R_{y} in formula (V) together with the nitrogen to which they are attached form a cyclic C₄-C₉ ring or Rₓ and R_{y} in formula (V) are each independently selected from a C₁-C₆ alkyl group or a C₄-C₁₀ aryl group; wherein R_{g6} in formula (V) is selected from CN or COOR, wherein R in formula (V) is hydrogen or a C₁-C₆ alkyl. Both the cis- and trans-isomers of formula (V) can be used. In an embodiment, the chromophore of formula (V) is a cis-isomer. In an embodiment, the chromophore of formula (V) is a trans-isomer. In an embodiment, Rₓ and R_{y} in formula (V) together with the nitrogen to which they are attached form a cyclic C₅-C₈ ring.

In some embodiments, the chromophore of formula (V) is represented by formula (Va):

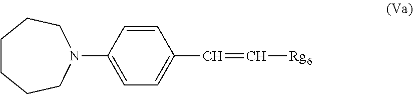

wherein R_{g6} in formula (Va) is selected from CN or COOR, wherein R in formula (Va) is hydrogen or a C₁-C₆ alkyl. Both the cis- and trans-isomers of formula (Va) can be used. In an embodiment, the chromophore of formula (Va) is a cis-isomer. In an embodiment, the chromophore of formula (Va) is a trans-isomer. In an embodiment, the chromophore of formula (Va) is selected from one of the following compounds.

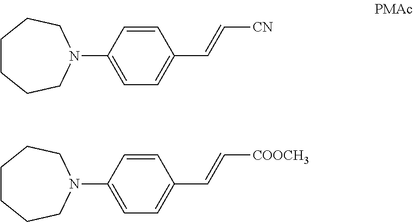 [SMILES: N#C/C=C/c1ccc(N2CCCCCC2)cc1 ; COC(=O)/C=C/c1ccc(N2CCCCCC2)cc1]

In some embodiments, the chromophore is represented by formula (VI):

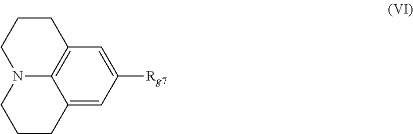

wherein R_{g7} in formula (VI) is selected from CN, CHO, or COOR, wherein R in formula (VI) is hydrogen or a C₁-C₆ alkyl. In an embodiment, the chromophore of formula (VI) is selected from one of the following compounds.

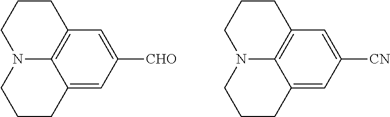 [SMILES: O=Cc1cc2c3c(c1)CCCN3CCC2 ; N#Cc1cc2c3c(c1)CCCN3CCC2]

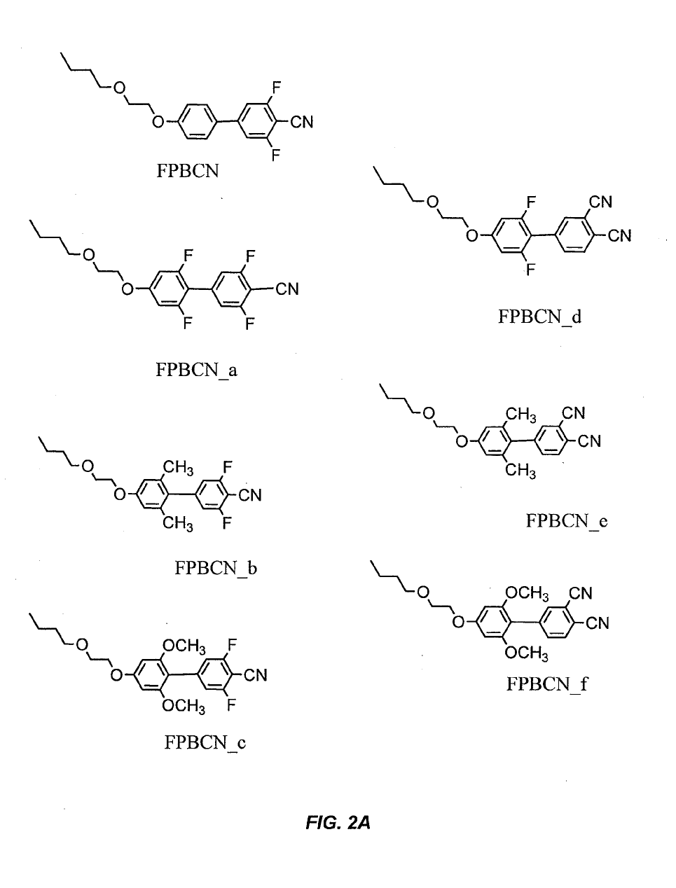

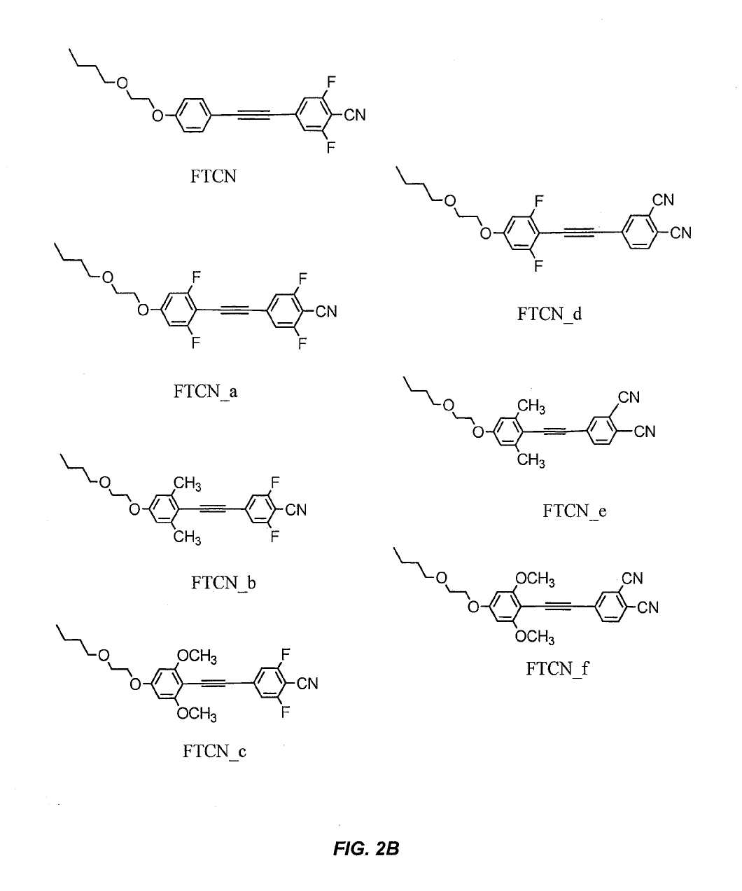

In some embodiments, the chromophore is represented by formula (VII):

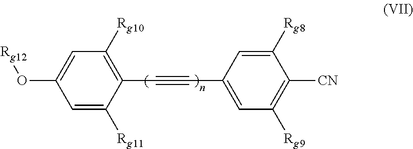

wherein n in formula (VII) is 0 or 1, R_{g8} and R_{g9} in formula (VII) are each independently selected from hydrogen, fluorine or CN, R_{g10} and R_{g11} in formula (VII) are each independently selected from hydrogen, methyl, methoxy, or fluorine, R_{g12} in formula (VII) is a C₁-C₁₀ oxyalkylene group containing 1 to 5 oxygen atoms or a C₁-C₁₀, alkyl group, and at least two of R_{g8}-R_{g12} in formula (VII) are not hydrogen. In an embodiment, at least three of R_{g8}-R_{g12} in formula (VII) are not hydrogen. In an embodiment, at least four of R_{g8}-R_{g12} in formula (VII) are not hydrogen. In an embodiment, R_{g12} in formula (VII) is —CH₂CH₂OCH₂CH₂CH₂CH₃. In an embodiment, the chromophore of formula (VII) is selected from the group of compounds shown in FIGS. 2A and 2B.

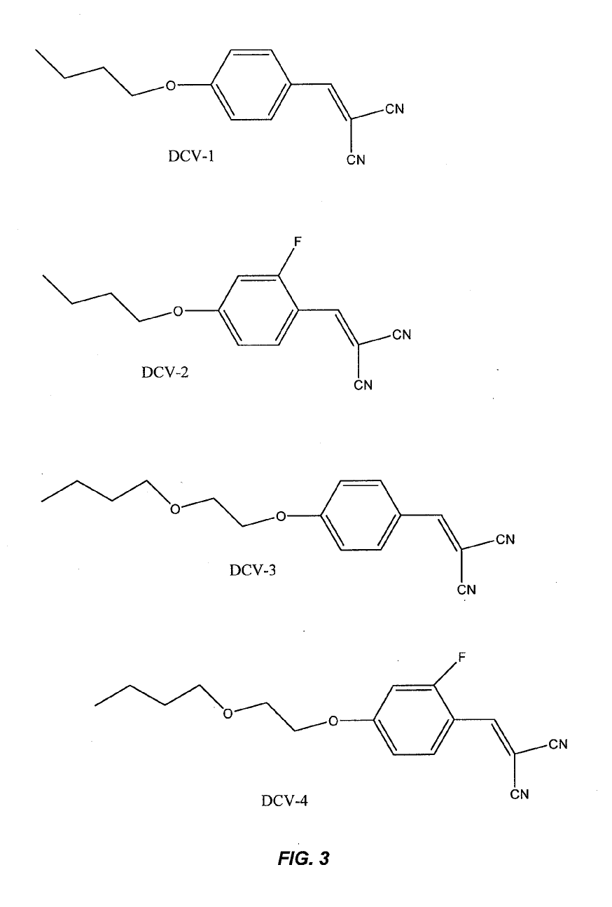

In some embodiments, the chromophore is represented by formula (VIII):

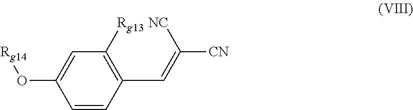

wherein R_{g13} in formula (VIII) is selected from hydrogen or fluorine, and R_{g14} in formula (VIII) is a C₁-C₆ alkyl or a C₁-C₁₀ oxyalkylene group containing 1 to 5 oxygen atoms. In an embodiment, R_{g14} is —CH₂CH₂OCH₂CH₂CH₂CH₃. In an embodiment, R_{g14} is a butyl group. In an embodiment, the chromophore of formula (VIII) is selected from the group of compounds shown in FIG. 3.

In the photorefractive composition, the chromophore provides a functionality that contributes to a refractive index change in response to the electric field. Several molecular parameters such as dipole moment (μ), polarizability anisotropy (Δα), and hyperpolarizability (b) are of importance for the electric field-induced refractive index change. It has been determined that a certain combination of these parameters, expressed in a property known as figure-of-merit (FOM), adequately describes the electro-optic non-linearity of a chromophore that is important for the photorefractive performance. The FOM is defined by the following equation:

FOM=1/M[9μβ+2μ²Δα/k_{b}T]

where M is the molar mass of the compound, k_{b} is Boltzmann constant, and T is the temperature.

In order to obtain a high contrast image in the blue color range, the photorefractive composition should not have strong absorbance in the blue color wavelength region. Applicants have discovered that if there is strong absorbance in the blue light region, then a hologram reading blue light can be absorbed entirely within the medium, resulting in no image contrast. Therefore, the chromophore should be selected so as to not result in a composition having a large absorbance in the blue region.

The chromophore described in U.S. Patent Application Publication No. 2009/0052009, 7FDCST, has a calculated absorbance peak of about 355 nm; however, the composition which contains 7FDCST is opaque in the blue color region. The inventors have discovered that, in order to avoid opaqueness in this region, the chromophore should have shorter peak absorbance wave-length than 7FDCST, but still have similar or better FOM. It is believed that the chromophores according to formulae (III), (IV), (V), (VI), (VII), and (VIII) meet this criteria, as shown below. The UV/VIS absorbance can be estimated by calculations based on molecular structure and functional group design.

The FOM and UV/VIS maximum absorbance peak values were calculated for several chromophore compounds according to formulae (III), (IV), (V), (VI), (VII), and (VIII) and compared to 7FDCST. The UV/VIS absorbance peaks for several chromophore compounds were also measured. FOM calculations for each chromophore were also performed. The following Table A summarizes the difference in maximum wavelength absorption for several chromophores in comparison to 7FDCST:

TABLE A
ABSORBANCE PEAKS AND FOM OF CHROMOPHORES

Δλmax(nm)
from 7FDCST

| Chromophore | Calculated | Measured | FOM |
|---|---|---|---|
| 7FDCST | 355 nm | 440 nm | 4.56 |
| FTCN_f | −8.2 | | 9.54 |
| FTCN_c | −10.3 | | 8.99 |
| FTCN_e | −11.0 | | 5.59 |
| PNO2CH3 | −11.7 | | 1.35 |
| FTCN_b | −14.0 | | 4.98 |
| PNO2 | −15.6 | −40 | 2.94 |
| FTCN | −19.5 | | 5.27 |
| FTCN_a | −20.8 | | 6.97 |
| FTCN_d | −20.9 | | 7.03 |
| DCV_1 | −34.4 | | 4.15 |
| DCV_2 | −36.0 | | 3.68 |
| DCV_3 | −40.9 | | 2.72 |
| DCV_4 | −42.4 | | 2.79 |
| PMAc | −43.7 | −75 | 3.61 |
| PDCN2 | −45.0 | | 2.81 |
| PDCN1 | −49.0 | −90 | 2.91 |
| FPBCN_f | −53.6 | | 5.02 |
| FPBCN_c | −62.3 | | 4.85 |
| FPBCN | −67.8 | | 3.42 |
| FPBCN_d | −77.3 | | 4.29 |
| FPBCN_e | −77.5 | | 2.55 |
| FPBCN_a | −78.5 | | 4.10 |
| FPBCN_b | −78.5 | | 2.22 |
| PMCN | −82.1 | −140 | 1.86 |

As can be seen in Table A, the calculated estimate for peak absorbance correlates reasonably well with the measured peak absorbance for several compounds, thus validating the calculated estimates for other compounds. As such, it is believed that each of the chromophores listed below 7FDCST in Table A, when mixed with the polymer in appropriate amounts to form a photorefractive composition, will configure the composition to be sensitive to the blue laser, and particularly to two or more color laser wavelengths. In preferred embodiments, the composition will be sensitive to a blue laser, and one or more of a green laser and a red laser.

The amount of chromophore in the photorefractive composition can vary. Preferably, the chromophore is provided in an amount that is sufficient to change the refractive index of the composition, such that it is sensitive to red, green, and blue light. In an embodiment, the chromophore provides a non-linear optical property to the composition such that, after irradiation of the composition, photorefractive grating signals can be detected. However, phase separation can result if too much chromophore is added into the composition. In an embodiment, chromophore is provided in the composition in an amount in the range of about 5% to about 60%, by weight based on the weight of the composition. In an embodiment, chromophore is provided in the composition in an amount in the range of about 10% to about 50% by weight based on the weight of the composition. In an embodiment, chromophore is provided in the composition in an amount in the range of about 20% to about 40% by weight based on the weight of the composition. In an embodiment, chromophore is provided in the composition in an amount in the range of about 25% to about 35% by weight based on the weight of the composition.

As used herein, a composition that absorbs light at each of the blue, green, and red laser wavelength is a composition that can absorb at least about 10% of incident working wavelength light. The incident working wavelength is the wavelength of the laser light that is used to irradiate the photorefractive composition. In some embodiments, the composition can absorb more than 10% of incident working wavelength light. In an embodiment, the composition absorbs at least about 20% of incident working wavelength light. In an embodiment, the composition absorbs at least about 30% of incident working wavelength light. In an embodiment, the composition absorbs at least about 40% of incident working wavelength light. In an embodiment, the composition absorbs at least about 50% of incident working wavelength light. In an embodiment, the composition absorbs at least about 60% of incident working wavelength light.

In an embodiment, the photorefractive composition comprises a sensitizer, selected and configured such that the photorefractive composition is photorefractive upon irradiation with more than one of a blue laser, a green laser, and a red laser. In an embodiment, the sensitizer can absorb light emitted at each of a blue laser wavelength, a green laser wavelength and a red laser wavelength. The sensitizer can aid in the absorption of the incident laser light and generate charge in the photorefractive composition. In an embodiment, the sensitizer, in conjunction with the selected chromophore and polymer, configures the photorefractive composition to absorb light at each of a blue laser wavelength, a green laser wavelength and a red laser wavelength.

One suitable sensitizer includes a fullerene. “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, and C₈₄, each of which may optionally be substituted. In an embodiment, the fullerene is selected from soluble C₆₀ derivative [6,6]-phenyl-C₆₁-butyricacid-methylester, soluble C₇₀ derivative [6,6]-phenyl-C₇₁-butyricacid-methylester, and soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents. Preferably, the substitution on the fullerene helps improve the solubility of the fullerene in a solvent used for dissolving the photorefractive composition. In an embodiment, the sensitizer is selected from the group consisting of an optionally substituted fullerene, optionally substituted phthalocyanine, optionally substituted perylene, optionally substituted porphyrin, and optionally substituted terrylene.

When included, the amount of sensitizer in the photorefractive composition can vary. Typically, sufficient sensitizer is included to provide the composition with photorefractive responsiveness to the working wavelength of irradiation, while not being so great in amount so as to decrease transmittance of the composition. For example, it is often desirable that the photorefractive composition have a transmittance of at least about 30%. Also, too much sensitizer in the composition can lead to phase separation. In an embodiment, the sensitizer is provided in the composition in an amount of about 0.01% to about 10% based on the weight of the composition. In an embodiment, the sensitizer is provided in the composition in an amount of about 0.05% to about 5% based on the weight of the composition. In an embodiment, the sensitizer is provided in the composition in an amount of about 0.1% to about 10% based on the weight of the composition. In an embodiment, the sensitizer is provided in the composition in an amount of about 0.05% to about 5% based on the weight of the composition. In an embodiment, the sensitizer is provided in the composition in an amount of about 0.1% to about 2% based on the weight of the composition.

In some embodiments, the photorefractive composition further comprises a plasticizer. Any commercial plasticizer such as phthalate derivatives or low molecular weight hole transfer compounds (e.g., N-alkyl carbazole or triphenylamine derivatives or acetyl carbazole or triphenylamine derivatives) may be incorporated into the polymer matrix. A N-alkyl carbazole or triphenylamine derivative containing electron acceptor group is a suitable plasticizer that can help the photorefractive composition be more stable, as the plasticizer contains both N-alkyl carbazole or triphenylamine moiety and non-linear optical moiety in one compound.

Other non-limiting examples of the plasticizer include ethyl carbazole; 4-(N,N-diphenylamino)-phenylpropyl acatate; 4-(N,N-diphenylamino)-phenylmethyloxy acatate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more compounds, which may be monomers. Also, un-polymerized monomers can be low molecular weight hole transfer compounds, for example 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

In some embodiments, a plasticizer may be selected from N-alkyl carbazole or triphenylamine derivatives of the formulae (IXa), (IXb), and/or (IXc):

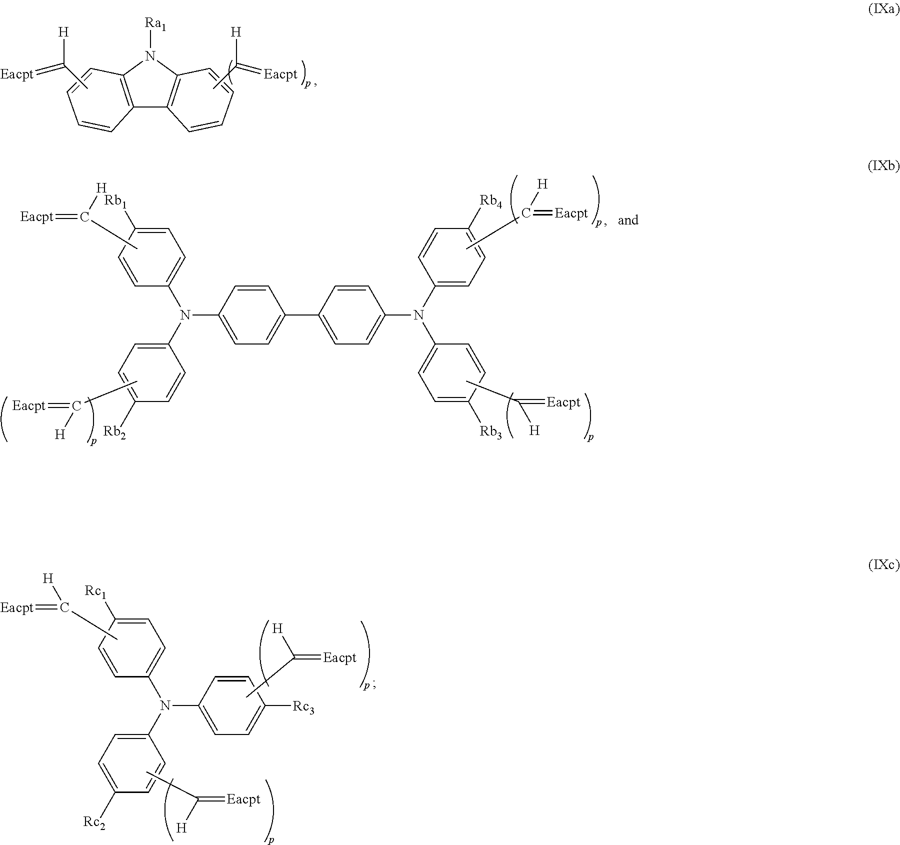

wherein Ra₁, Rb₁-Rb₄ and Rc₁-Rc₃ in formulae (IXa), (IXb), and (IXc) are each independently selected from the group consisting of hydrogen, branched and linear C₁-C₁₀ alkyl, and C₄-C₁₀ aryl; p is 0 or 1; Eacpt in formulae (IXa), (IXb), and (IXc) is —O or represented by a structure selected from the group consisting of the following formulae;

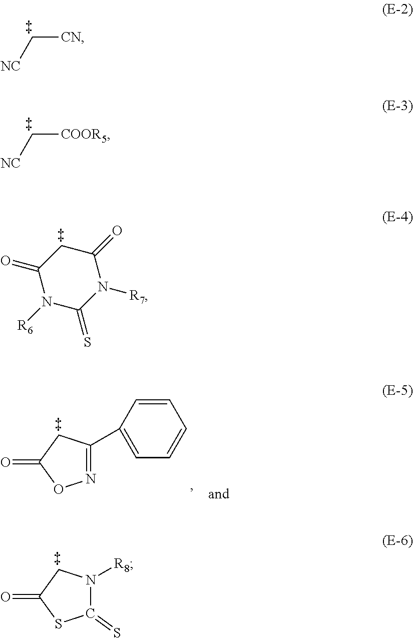

wherein R₅, R₆, R₇ and R₈ in formulae (E-3), (E-4) and (E-6) are each independently selected from the group consisting of hydrogen, linear and branched C₁-C₁₀ alkyl, and C₄-C₁₀ aryl.

Other non-limiting examples of the plasticizer include the following structures;

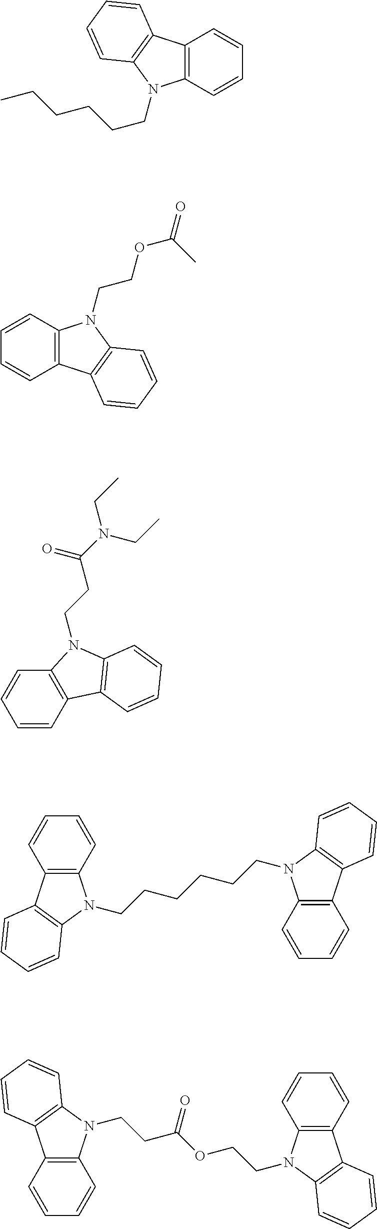 [SMILES: CCCCCCn1c2ccccc2c2ccccc21 ; CC(=O)OCCn1c2ccccc2c2ccccc21 ; CCN(CC)C(=O)CCn1c2ccccc2c2ccccc21 ; c1ccc2c(c1)c1ccccc1n2CCCCCCn1c2ccccc2c2ccccc21 ; O=C(CCn1c2ccccc2c2ccccc21)OCCn1c2ccccc2c2ccccc21]

Organic photorefractive materials often incorporate N-ethylcarbazole (ECz) as a plasticizer to control the Tg of the material in an attempt to keep it around room temperature. The use of ECz can be problematic, however, because the high-temperature conditions required to process it into devices causes it to sublime out of the composite, which also detrimentally alters the ratio of the remaining components. This can be problematic when trying to scale the size of the device, as well as when trying to do any material optimization work. Large variations in photorefractive efficiency, as measured by 4WM and 2BC techniques, can be observed even within the same device as a result. As such, new plasticizer materials with a higher sublimation point are highly desirable. Sublimation point can be increased by increasing the molecular weight. One example of such a plasticizer is N-(1-hexyl)-carbazole.

Another option is dimerizing a carbazole compound. With this option, the molecular weight and sublimation point can both be increased without diluting the carbazole moiety per unit of volume. For example, 1,6-di-(9-carbazolyl)hexane was prepared due to its high sublimation point compared to ethylcarbazole and low melting point relative to 1,3-di-(9-carbazolyl)propane, 1,4-di-(9-carbazolyl)butane, 1,5-di-(9-carbazolyl)pentane, and 1,10-di-(9-carbazolyl)decane. 1,3-di-(9-carbazolyl)propane was reported in photorefractive compositions according to Seminar Material, “Holographic Memory Applications & New Material,” “Holographic Memory Applications & New Photorefractive Material,” Prof Nagayama (Univ. of Osaka), Feb. 21, 2007. However, it has a very high melting point compared to 1,6-di-(N-carbazoyl) hexane (185° C. vs. 126° C.), and its incorporation into compositions significantly increases their Tg. Additionally, its incorporation also increases viscosity at processing temperatures, leading to another technical problem of inescapable bubble defects—both undesirable traits.

Other esters are useful to increase the average molecular weight of the composition, and thus sublimation point, including 2-(9-carbazolyl)ethyl acetate and 2-(9-carbazolyl)ethyl 3-(9-carbazolyl)propanoate. Another compound useful for increasing the average molecular weight of the composition is the amide, 3-(9H-carbazol-9-yl)-N,N-diisopropylpropanamide.

In some embodiments, the photorefractive composition comprises a copolymer that provides photoconductive (charge transport) ability and non-linear optical ability. The photorefractive composition may also include other components as desired, such as sensitizer and/or plasticizer components. Some embodiments provide a photorefractive composition that comprises a copolymer. The copolymer may comprise a first repeating unit that includes a first moiety with charge transport ability, a second repeating unit including a second moiety with non-linear optical ability, and a third repeating unit that include a third moiety with plasticizing ability.

In addition, the ratio of different types of monomers used in forming the copolymer may be varied over a broad range. Some embodiments may provide a photorefractive composition with the first repeating unit (e.g., the repeating unit with charge transport ability) to the second repeating unit (e.g., the repeating unit with non-linear optical ability) weight ratio of about 100:1 to about 0.5:1, preferably about 10:1 to about 1:1. When the ratio of the first repeating unit to the second repeating unit is smaller than 0.5:1, the charge transport ability of copolymer may be weak, and the response time may be undesirably slow to give good photorefractivity. However, even in this case, the addition of already described low molecular weight components having non-linear-optical ability can enhance photorefractivity. On the other hand, if the weight ratio is larger than 100:1, the non-linear optical ability of copolymer itself is weak, and the diffraction efficiency tends to be too low to give good photorefractivity. However, even in this case, the addition of already described low molecular weight components having charge transport ability can enhance photorefractivity.

In some embodiments, the molecular weight and the glass transition temperature, Tg, of the copolymer are selected to provide desirable physical properties. In some embodiments, it is valuable and desirable, although not essential, that the polymer is capable of being formed into films, coatings and shaped bodies of various kinds by standard polymer processing techniques (e.g., solvent coating, injection molding or extrusion).

In some embodiments, the polymer has a weight average molecular weight, Mw, in the range of from about 3,000 to about 500,000, preferably from about 5,000 to about 100,000. The term “weight average molecular weight” as used herein means the value determined by the GPC (gel permeation chromatography) method using polystyrene standards, as is well known in the art. In some embodiments, additional benefits may be provided by lowering the dependence on plasticizers. By selecting copolymers with intrinsically moderate Tg and by using methods that tend to depress the average Tg, it is possible to limit the amount of plasticizer required for the composition to no more than about 30% or 25%, and in some embodiments, no more than about 20%. In some embodiments, the photorefractive composition that can be activated by full color lasers may have a thickness of about 100 μm and a transmittance of higher than about 30% at all blue, green and red wavelengths.

An embodiment provides a photorefractive composition that is photorefractive upon irradiation by two or more of a red laser, green laser, and a blue laser, wherein the photorefractive composition comprises a polymer comprising a first repeating unit that includes at least one moiety selected from the group consisting of the formulae (Ia), (Ib), and (Ic) as defined above. In some embodiments, the polymer may further comprise a second repeating unit comprising at least one moiety selected from formula (IIa). In some embodiments, the polymer may further comprise a third repeating unit that includes at least one moiety selected from formulae (IXa), (IXb) and (IXc). In an embodiment, an optical device comprises the photorefractive any one of the compositions described herein. In some embodiments, the photorefractive composition may further comprise a chromophore selected from formulae (III), (IV), (V), (VI), (VII), and (VIII). In some embodiments, the photorefractive composition may further comprise a sensitizer.

In an embodiment, the photorefractive composition both has the ability to absorb light at different wavelengths and also transmit light at different wavelengths. In order for the photorefractive device to be responsive to any given laser wavelength, the photorefractive composition should have absorption, as well as transmission at the wavelength of the measurement. The absorption of the incident light is necessary to initialize the response of the device. The transmission is needed for future reading of the grating at the wavelength of interest, including from about 400 nm to about 700 nm. Preferably, the transmission of the sample is from about 20 to about 90%. In an embodiment, the transmission is from about 40% to about 80%. In an embodiment, the transmission is from about 40% to about 60%. The photorefractive device can be irradiated with blue, green, or red laser and the transmitted light intensity is measured with and without the PR device in place. In an embodiment, the composition has a transmittance of higher than about 20% at a thickness of 100 μm when irradiated by two or more of a blue laser, a green laser, and a red laser. In an embodiment, the composition has a transmittance of higher than about 30% at a thickness of 100 μm when irradiated by two or more of a blue laser, a green laser, and a red laser. In an embodiment, the composition has a transmittance of higher than about 40% at a thickness of 100 μm when irradiated by two or more of a blue laser, a green laser, and a red laser. In an embodiment, the composition has a transmittance of higher than about 50% at a thickness of 100 μm when irradiated by two or more of a blue laser, a green laser, and a red laser.

Another embodiment provides a method of modulating light, comprising providing a photorefractive composition (e.g., a photorefractive composition as described herein) that comprises a polymer, a chromophore, and a sensitizer, wherein the polymer comprises a repeating unit that includes a moiety selected from the group consisting of the formulae (Ia), (Ib), and (Ic), and irradiating the photorefractive composition with two or more of a blue laser, a green laser and a red laser to thereby modulate a photorefractive property of the composition. In an embodiment, modulating a photorefractive property comprises activating the photorefractive composition. In an embodiment, the photorefractive composition is irradiated with a blue laser, a green laser, and a red laser.

Many currently available photorefractive polymers have poor phase stabilities and can become hazy after several days. If the film composition comprising the photorefractive polymer shows haziness, poor photorefractive properties are exhibited. The haziness of the film composition can result from incompatibilities between several photorefractive components. For example, photorefractive compositions containing both charge transport ability components and non-linear optical ability components exhibit haziness because the components having charge transport ability are usually hydrophobic and non-polar, whereas components having non-linear optical ability are usually hydrophilic and polar. As a result, the natural tendency of the composition is to phase separate.

However, various embodiments presented herein show very good phase stability and no haziness is observed, even after several months. Such compositions described herein retain good photorefractive properties, as the compositions are very stable and exhibit little or no phase separation. Without being bound by theory, the stability is likely attributable to the chromophore structures and/or a mixture of various chromophores. In addition, the matrix polymer system can be a copolymer of components having charge transport ability and components having non-linear optical ability. That is, the components having charge transport ability and the components having non-linear optical ability can coexist in one polymer chain, further decreasing the extent or possibility of phase separation.

Furthermore, although heat usually increases the rate of phase separation, embodiments of the compositions described herein exhibit good phase stability, even after being heated. For heat acceleration tests, the samples were typically heated to a temperature in the range of about 40° C. to about 120° C., preferably in the range of about 60 to about 80° C. The heated samples were found to be stable after days, weeks and sometimes even after 6 months. The good phase stability allows the copolymer to be further processed and incorporated into optical device applications for more commercial products.

In some embodiments, the composition is configured to transmit blue, green and red wavelength laser beams. The composition transmittance depends on the photorefractive layer thickness, thus by controlling the thickness of the photorefractive layer comprising a photorefractive composition, the light modulating characteristics can be adjusted as desired. When the transmittance is low, the laser beam may not pass through the layer to form grating image and signals. On the other hand, if the absorbance is absent, no laser energy can be absorbed to generate grating signals. In some embodiments, the range of transmittance is from about 10% to about 99.99%. In an embodiment, the range of transmittance is from about 30% to about 99.9%. In an embodiment, the range of transmittance is from about 40% to about 90%. Lin ear transmittance was measured to determine the absorption coefficient of the photorefractive device. For measurements, a photorefractive layer was exposed to a 488 nm, a 532 nm and a 633 nm laser beam with an incident path perpendicular to the layer surface. The beam intensity before and after passing through the photorefractive layer is monitored and the linear transmittance of the sample is given by:

$$T = {I}_{Transmitted} / {I}_{incident}$$

One of the many advantages of the photorefractive compositions described herein is a fast response time. Faster response times mean faster grating build-up, which enables the photorefractive composition to be used for wider applications, such as real-time hologram applications. Response time is the time needed to build up the diffraction grating in the photorefractive material when exposed to a laser writing beam. The response time of a sample of material may be measured by transient four-wave mixing (TFWM) experiments, as detailed in the Examples section below. The data may then be fitted with the following bi-exponential function:

η(t)=sin²{η₀(1−a₁e^{-t/J1}−a₂e^{-t/J2})}

with a₁+a₂=1; where η(t) is the diffraction efficiency at time t, η₀ is the steady-state diffraction efficiency, and J₁ and J₂ are the grating build-up times. The smaller number of J₁ and J₂ is defined as the response time. In an embodiment, the composition has a response time of less than about 5 seconds upon irradiation with two or more of a red laser, a green laser, and a blue laser. In an embodiment, the composition has a response time of less than about 3 seconds upon irradiation with two or more of a red laser, a green laser, and a blue laser.

Furthermore, the fast response time can be achieved without using a high electric field, such as a field in excess of about 100 V/μm (expressed as biased voltage). For the samples described herein, a fast response time can generally be achieved at a biased voltage no higher than about 100 V/μm, including in the range of about 95 to about 50 V/μm. In an embodiment, the response time is achieved using an electric field in the range of about 90 to about 60 V/μm. Embodiments of the photorefractive compositions described herein have demonstrated a fast response time at each of the visible light wavelength lasers. One of many advantages of the preferred compositions is the photostability retained upon exposure to each of the lasers. Various samples described herein provide good photostability even after a long exposure time to the high power lasers.

Another one of many advantages is the high diffraction efficiency, Diffraction efficiency is defined as the ratio of the intensity of a diffracted beam to the intensity of an incident probe beam, and is determined by measuring the intensities of the respective beams. Various samples of embodiments described herein provide a diffraction efficiency of at least about 20% upon irradiation by two or more of a blue laser, a green laser and a red laser. In an embodiment, the photorefractive compositions described herein provide a diffraction efficiency of at least about 20% upon irradiation by each of a blue laser, a green laser and a red laser. In an embodiment, the photorefractive compositions provide a diffraction efficiency of at least about 25% upon irradiation by two or more of a blue laser, a green laser and a red laser. In an embodiment, the photorefractive compositions provide a diffraction efficiency of at least about 25% upon irradiation by each of a blue laser, a green laser and a red laser. In an embodiment, the photorefractive compositions provide a diffraction efficiency of at least about 30% upon irradiation by two or more of a blue laser, a green laser and a red laser. In an embodiment, the photorefractive compositions provide a diffraction efficiency of at least about 30% upon irradiation by each of a blue laser, a green laser and a red laser. In an embodiment, the photorefractive compositions provide a diffraction efficiency of at least about 40% upon irradiation by two or more of a blue laser, a green laser and a red laser. In an embodiment, the photorefractive compositions provide a diffraction efficiency of at least about 40% upon irradiation by each of a blue laser, a green laser and a red laser.

The embodiments are now further described by the following examples, which are intended to be illustrative of the invention, but are not intended to limit the scope or underlying principles in any way.

### Syntheses and Production Methods

### Production Method 1

### (a) Monomers Containing Charge Transport Groups

N-[acroyloxypropoxyphenyl]-N,N′,N′-triphenyl-(1,1′-biphenyl)-4,4′-diamine (TPD acrylate) monomer was purchased from Wako Chemical, Japan, and has the following structure:

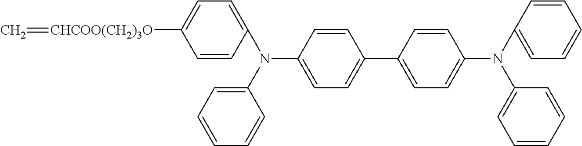

### (b) Monomers Containing Non-Linear Optical Groups

The non-linear optical precursor monomer 5-[N-ethyl-N-4-formylphenyl]amino-pentyl acrylate was synthesized according to the following synthesis scheme:

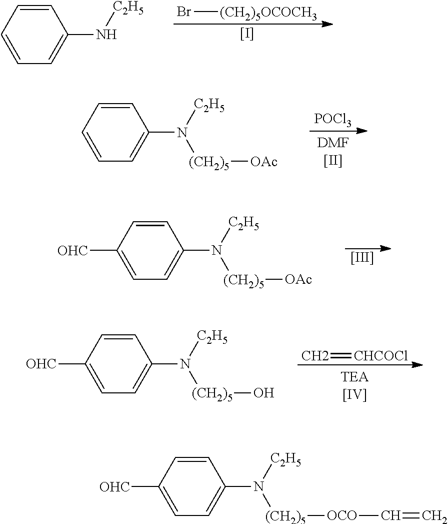

STEP I: Bromopentyl acetate (5 mL, 30 mmol), toluene (25 mL), triethylamine (4.2 mL, 30 mmol), and N-ethylaniline (4 mL, 30 mmol) were added together at room temperature. The mixture was heated at 120° C. overnight. After cooling down, the reaction mixture was rotary-evaporated to form a residue. The residue was purified by silica gel chromatography (developing solvent: hexane/acetone=9/1). An oily amine compound was obtained. (Yield: 6.0 g (80%)).

STEP II: Anhydrous DMF (6 mL, 77.5 mmol) was cooled in an ice-bath. Then, POCl₃ (2.3 mL, 24.5 mmol) was added dropwise into the cooled anhydrous DMF, and the mixture was allowed to come to room temperature. The amine compound (5.8 g, 23.3 mmol) was added through a rubber septum by syringe with dichloroethane. After stirring for 30 min., the reaction mixture was heated to about 90° C. and the reaction was allowed to proceed overnight under an argon atmosphere. After the overnight reaction, the reaction mixture was cooled and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate-3/1). An aldehyde compound was obtained. (Yield: 4.2 g (65%)).

STEP III: The aldehyde compound (3.92 g, 14.1 mmol) was dissolved in methanol (20 mL). Into the solution, potassium carbonate (400 mg) and water (1 mL) were added at room temperature and the solution was stirred overnight. Next, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%)).

STEP IV: The aldehyde alcohol (5.8 g, 24.7 mmol) was dissolved in anhydrous THF (60 mL). Into the solution, triethylamine (3.8 mL, 27.1 mmol) was added and the solution was cooled by ice-bath. Acrolyl chloride (2.1 mL, 26.5 mmol) was added and the solution was maintained at 0° C. for 20 minutes. Thereafter, the solution was allowed to warm up to room temperature and stirred at room temperature for 1 hour, at which point TLC indicated that the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=1/1). The compound yield was 5.38 g (76%), and the compound purity was 99% (by GC).

### (c) Synthesis of Non-Linear Optical Chromophore 7FDCST

The non-linear optical precursor 7FDCST (7 member ring dicyanostyrene, 4-homopiperidino-2-fluorobenzylidene malononitrile) was synthesized according to the following two-step synthesis scheme:

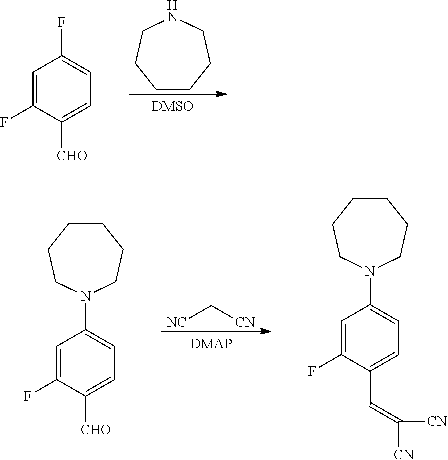

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. The compound yield was 18.1 g (38%).

(d) Synthesis of Non-Linear Optical Chromophore 4-(azepan-1-yl)benzonitrile (PMCN)

The Non-Linear-Optical Chromophore 4-(Azepan-1-yl)benzonitrile was synthesized according to the following synthesis scheme:

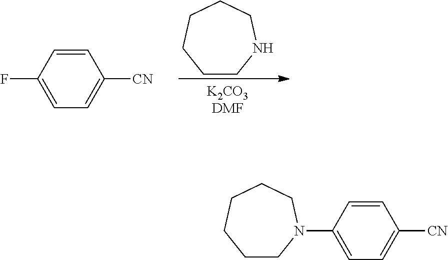 [SMILES: N#Cc1ccc(F)cc1 ; C1CCCNCC1 ; N#Cc1ccc(N2CCCCCC2)cc1]

A mixture of 4-fluorobenzonitrile (4.5 g, 37 mmol), homopiperidine (9 g, 90 mmol), potassium carbonate (19 g, 137 mmol), and DMF (15 mL) was stirred at 75° C. for 16 hours. Water (50 mL) was then added to the reaction mixture. The products were extracted with ether (100 mL). After removal of ether, the crude products were recrystallized and a white crystal was obtained. The compound yield was 4.3 g (58%).

(e) Synthesis of Non-Linear Optical Chromophore methyl 3-(4-(azepan-1-yl)phenyl)acrylate (PMAc)

The non-linear-optical chromophore methyl 3-(4-(azepan-1-yl)phenyl)acrylate was synthesized according to the following synthesis scheme:

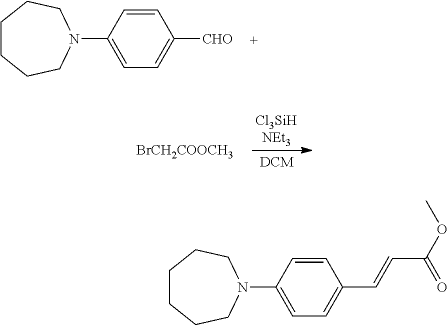

In a 250 mL two-neck flask, anhydrous methylene chloride (60 mL) and 4-(azepan-1-yl)benzaldehyde (4.06 g, 20 mmol) were added. Then, methyl 2-bromoacetate (7.04 g, 46 mmol) followed by triethylamine (10.1 g, 100 mmol) and trichlorosilane (5.41 g, 40 mmol) were added at −10° C. under nitrogen atmosphere. The mixture was stirred at −10° C. for 8 hours and then gradually warmed to room temperature overnight. The reaction mixture was quenched by saturated NaHCO₃ aqueous solution and water. The products were extracted with ether and washed by brine and dried over MgSO₄. The crude products were purified by column. The compound yield was 2.48 g (48%).

### (f) Sensitizer

Sensitizer C₆₀ derivative [6,6]-phenyl-C₆₁-butyric acid methyl ester (PCBM, 99%, American Dye Source Inc.) and C₇₀ derivative [6,6]-phenyl-C₇₁-butyric acid methyl ester (99%, mixture of isomers, Aldrich) are commercially available and were used as received from purchase.

### (g) Plasticizer

N-ethylcarbazole is commercially available from Aldrich and was used after recrystallization.

### Production Method 2

### Preparation of TPD Acrylate/Chromophore Type 10:1 Copolymer by AIBN Radical Initiated Polymerization

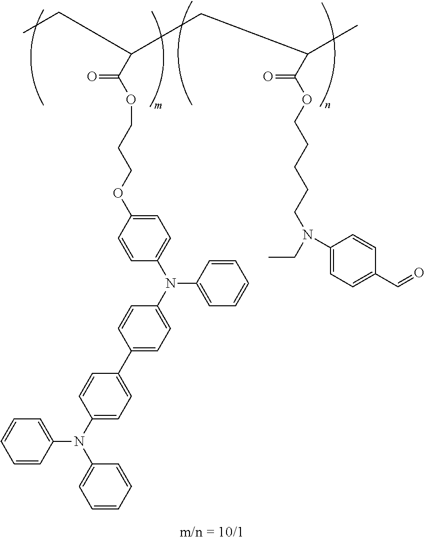

The charge transport monomer N-[(meth)acroyloxypropylphenyl]-N,N′,N′-triphenyl-(1,1′-biphenyl)-4,4′-diamine (TPD acrylate) (43.34 g), and the non-linear optical precursor monomer 5-[N-ethyl-N-4-formylphenyl]amino-pentyl acrylate (4.35 g), prepared as described in Example 1, were put into a three-necked flask. After toluene (400 mL) was added and purged by argon gas for 1 hour, azoisobutylnitrile (118 mg) was added into the solution. Then, the solution was heated to 65° C., while continuing to purge with argon gas.

After 18 hours of polymerization, the polymer solution was diluted with toluene. The polymer was precipitated from the solution and added to methanol, and the resulting polymer precipitate was collected and washed in diethyl ether and methanol. The white polymer powder was collected and dried. The yield of polymer was 66%.

The weight average and number average molecular weights were measured by gel permeation chromatography, using polystyrene standard. The results were Mn=10,600, Mw=17,100, giving a polydispersity of 1.61.

### Syntheses

### Synthesis of N-(1-hexyl)-carbazole

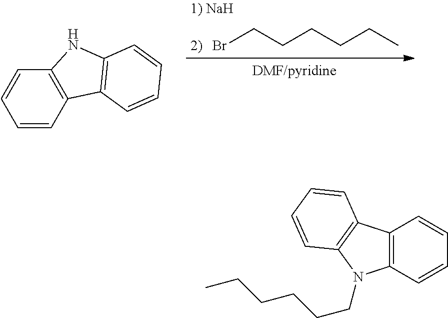

N-(1-hexyl)-carbazole was synthesized according to a minor modification of the procedure reported in Bull. Korean Chem. Soc., 26(1), 77. A suspension of carbazole (20 g, 120 mmol) in 40 mL of DMF and 15 mL of pyridine (to assist dissolution) was added to a suspension of NaH (5.76 g, 144 mmol) in 80 mL of DMF at 0° C. under an Ar atmosphere. The ice-bath was removed and the suspension was stirred for 1.5 hrs at ambient temperature. Then, the suspension was cooled again to 0° C., at which point a solution of 1-bromohexane (23.7 g, 144 mmol) in 20 mL of DMF was added dropwise. The solution was stirred for a further 20 minutes at 0° C., at ambient temperature for 1 hour, then at 50° C. for 1 hour, and then at ambient temperature overnight. The work-up was performed as described in the reference, and was additionally purified by two crystallizations from ethanol and obtained as a white needle-like crystalline solid. Yield=19 g (63%). m.p.=62.5-64.1° C.

### Synthesis of 2-(9-carbazolyl)ethyl acetate

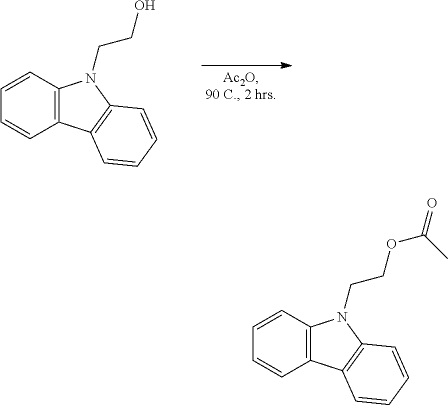 [SMILES: OCCn1c2ccccc2c2ccccc21 ; CC(=O)OCCn1c2ccccc2c2ccccc21]

N-carbazolethanol (4.92 g, 23.3 mmol) and acetic anhydride (11 g, 109 mmol) were stirred at 90° C. for 2 hours, at which point, the reaction mixture was cooled to room temperature and added to a separatory funnel containing a mixture of ice-cold water and dichloromethane. The organic phase was washed with ice-cold aqueous NH₄OH, followed by brine. The organic phase was then dried with Na₂SO₄, and evaporated to dryness. The crude material was column purified with silica gel as the stationary phase and 25% hexane in dichloromethane as the mobile phase. 4.25 g of clear colorless oil was obtained, which was recrystallized from ethanol to yield white needle-like crystals. Yield=3.6 g (61%). m.p. 73.0-74.5° C. ¹H-NMR (400 MHz, 1,1,2,2-tetrachloroethane): δ=8.08 (d; J=7.7 Hz; 2H), 7.50-7.40 (m; 4H), 7.24 (t; J=7.7 Hz; 2H), 4.52 (t; 2H), 4.43 (t; 2H), 1.92 (t; 3H).

### Synthesis of 1,6-di-(9-carbazolyl)hexane

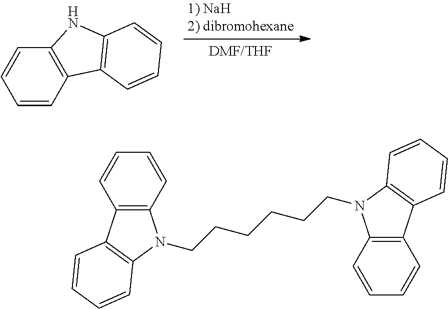 [SMILES: c1ccc2c(c1)[nH]c1ccccc12 ; c1ccc2c(c1)c1ccccc1n2CCCCCCn1c2ccccc2c2ccccc21]

1,6-di-(9-carbazolyl)hexane was prepared in accordance with the procedure detailed in J. Chem. Mater., 2001, 11, 2790-2800. It was crystallized twice from ethanol to yield white cotton-like crystals. Yield=7.5 g (63%). m.p. 124-126° C.

### Synthesis of 3-(9-carbazolyl)-N,N-diethylpropanamide

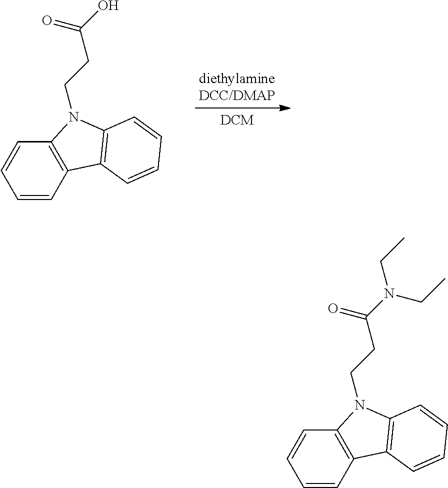 [SMILES: O=C(O)CCn1c2ccccc2c2ccccc21 ; CCN(CC)C(=O)CCn1c2ccccc2c2ccccc21]

Carbazolpropionic acid (800 mg, 3.35 mmol), diethylamine (246 mg, 3.37 mmol), dicyclohexylcarbodiimide (690 mg, 3.35 mmol), and diethylaminopyridine (163 mg, 1.34 mmol) were dissolved in 10 mL of dichloromethane and stirred at room temperature for 2 hours. Some hexane was added to further precipitate the salts, which were filtered off and discarded. The filtrate was purified by silica gel chromatography using dichloromethane as the mobile phase. A colorless oil was recovered. Yield=900 mg (91%). ¹H-NMR (400 MHz, 1,1,2,2-tetrachloroethane): δ=8.08 (d; J=7.7 Hz; 2H), 7.46 (d; J=4.0 Hz; 4H), 7.25-7.18 (m; 2H), 4.66 (t, 2H), 3.31 (q; 2H), 3.03 (q; 2H), 2.77 (t; 2H), 1.03 (t; 3H), 0.96 (t; 3H).

### Synthesis of 2-(9-carbazolyl)ethyl 3-(9-carbazolyl)propanoate

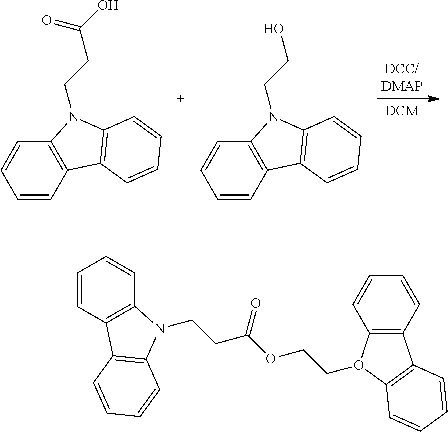

Carbazolpropionic acid (600 mg, 2.51 mmol), carbazole ethanol (530 mg, 2.51 mmol), dicyclohexylcarbodiimide (517 mg, 2.51 mmol), and diethylaminopyridine (122 mg, 1.00 mmol) were dissolved in 12 mL of dichloromethane and stirred at room temperature for 2 hours. Some hexane was added to further precipitate the salts, which were filtered off and discarded. The filtrate was purified by silica gel chromatography using 12% hexane in dichloromethane as the mobile phase. The product was further purified by recrystallization from ethanol to yield a white cotton-like crystalline solid. Yield=680 mg (63%). ¹H-NMR (400 MHz, 1,1,2,2-tetrachloroethane): δ=8.05 (d; J=7.7 Hz; 4H), 7.39 (m; 4H), 7.22 (m; 8H), 4.39 (t; 2H), 4.34 (s; 4H), 2.66 (m; 2H). m.p. 163-165° C.

### Synthesis of PDCN1 Chromophore

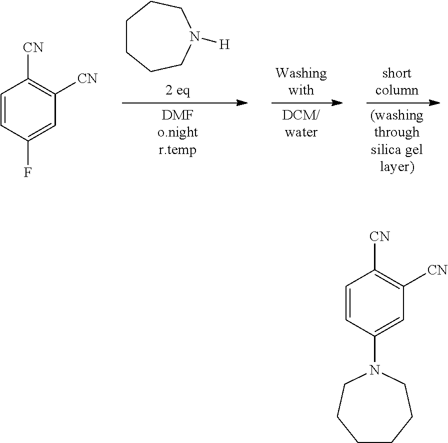 [SMILES: N#Cc1ccc(F)cc1C#N ; C1CCCNCC1 ; N#Cc1ccc(N2CCCCCC2)cc1C#N]

A solution of 4-Fluorophthalonitrile (5.2 g, 30 mmol) in DMF (25 ml) was stirred overnight with Hexamethyleneimine (6.0 ml, 60 mmol) in a 50 ml RB flask with septa and argon inlet and outlet (using 2 needles). The reaction progress was monitored by LCMS and/or NMR for complete transformation of the nitro compound to the amino desired product. Monitoring using TLC did not allow one to see the unreacted nitro compound. So, monitoring with LCMS and/or NMR was used because of the difficulty involved with separating starting material from the product. Separation was not performed by column or by recrystallization. When the reaction was finished, it was transferred to a separating funnel as solution in DCM (200 ml) and washed 3 times with water. The organic layer was dried over anhydrous Na₂SO₄ anhydrous and the solvent removed in vacuo. Purification occurred by filtering through 2 in. layer of silica gel in approx. 2 inch diameter column. Recrystallization from EtOH gave ivory color needles (4.39 g, 65%). ¹H NMR (CDCl₃, 400 MHz): 7.49 (d, 5.5 Hz), 6.91 (d, 1.5 Hz), 6.80 (dd, J₁=5.5, J₂=1.5 Hz), 3.49 (m, 4H), 1.80 (m, 4H), 1.56 (m, 4H).

### Synthesis of Julolidine-CHO

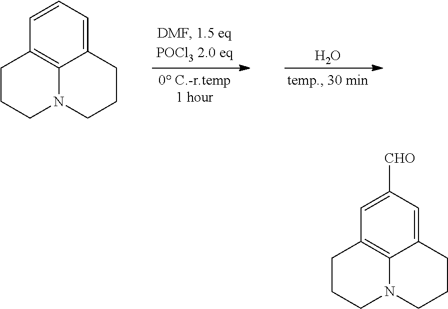 [SMILES: c1cc2c3c(c1)CCCN3CCC2 ; O ; O=Cc1cc2c3c(c1)CCCN3CCC2]

To Julolidine solution in dry DCM (5 ml) and dry DMF (2.5 ml), POCL₃ (3.6 ml, 40 mmol) was added dropwise at 0° C. The reaction was later allowed to warm-up to room temperature and was monitored by TLC. After 1 hour, hot water (100 ml) was added portion-wise and the reaction mixture was left stirred at a water bath (approx. 80° C.) for one hour. After cooling, the product was extracted with ethyl acetate (2×100 ml). The organic layer was washed with water until the strong blue color of the organic layer was gone. The product was dried over anhydrous Na₂SO₄ and the solvent was removed in vacuo to give greenish oily product which solidified (1.85 g, 92%). ¹H NMR (CDCl₃, 400 MHz): 9.58 (s, CHO), 7.27 (s, 2H), 3.27 (m, 4H), 2.74 (m, 4H), 1.94 (m, 4H).

Synthesis of Julolidine-Oxime: To a solution of Jul-aldehyde (1.26 g, 6 mmol) in MeOH (20 ml), a solution of hydroxylamine hydrochloride (630 mg, 9 mmol) and CH₃COOK (2.4 g, 12 mmol) in water (20 ml) was added. The reaction mixture was heated at approx. 60° C. for two hours, and then allowed to cool. The orange-brownish solid was separated by filtration, washed with water and dried (1.31 g, 100%)). NMR (CDCl₃, 400 MHz): 8.8 (bs, OH), 7.97 (s, 1H), 7.00 (s, 2H), 3.20 (m, 4H), 2.73 (m, 4H), 1.94 (m, 4H).

### Synthesis of Julolidine-CN

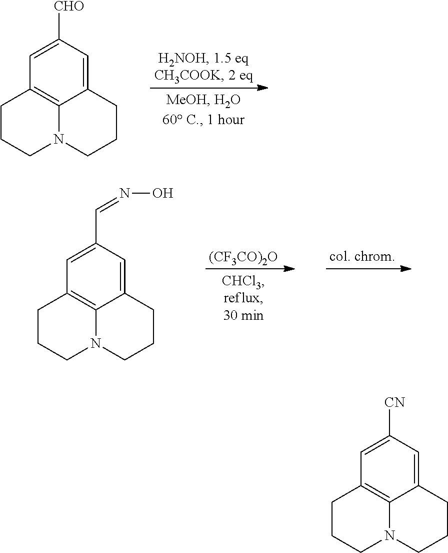

To a solution of Julolidine-oxime (1.30 g, 6 mmol) in CHCl₃ (20 ml), (CF₃CO)₂O (1.0 ml) was added in one portion and the reaction mixture was left stirred at 60° C. for 20 minutes. The reaction was monitored by TLC. After cooling, water was added and neutralized with NaHCO₃. The product was extracted with DCM and the organic layer was washed with water. After drying over anhydrous Na₂SO₄, the solvent was removed in vacuo to give 980 mg of white powder (82%). ¹H NMR (CDCl₃, 400 MHz): 7.00 (s, 2H), 3.22 (m, 4H), 2.68 (m, 4H), 1.91 (m, 4H). C₁₃H₁₄N₂, MW-198.12

### EXAMPLES

### Example 1

### Preparation of Photorefractive Composition

A photorefractive composition testing sample was prepared. The components of the composition, prepared as described in the above production methods, were as follows:

| | | |
|---|---|---|
| (i) TPD charge transport (described in Production Method 2): | 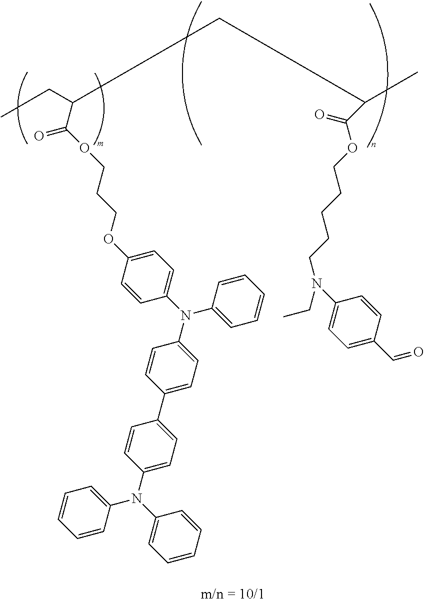 | 49.90 wt % |
| (ii) Chromophore of methyl 3-(4-(azepan-1- yl)phenyl)acrylate: | 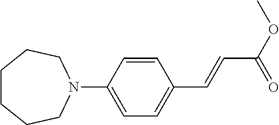 [SMILES: COC(=O)/C=C/c1ccc(N2CCCCCC2)cc1] | 29.94 wt % |
| (iii) 9-ethylcarbazole plasticizer: | 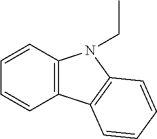 | 19.96 wt % |
| (iv) PCBM Sensitizer: | 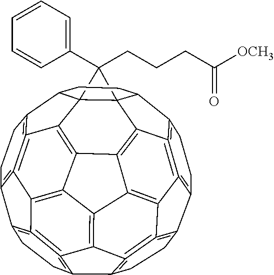 | 0.20 wt % |

To prepare the composition, the components listed above were dissolved in dichloromethane with stirring and then dripped onto glass plates at 60° C. using a filtered glass syringe. The resulting composites were then heated to 60° C. for five minutes and then vacuumed for five more minutes. The composites were then heated to 150° C. for five minutes and then vacuumed for 30 seconds. The composites were then scrapped and cut into chunks.

Small portions of this chunk were taken off and sandwiched between indium tin oxide (ITO) coated glass plates separated by a 105 μm spacer to form the individual samples.

### Measurement 1: Diffraction Efficiency

The diffraction efficiency was measured at 488 nm (e.g., blue), 532 nm, (e.g., green), and 633 nm (e.g., red), respectively by four-wave mixing experiments. Steady-state and transient four-wave mixing experiments were done using two writing beams making an angle of 20.5 degree in air; with the bisector of the writing beams making an angle of 60 degree relative to the sample normal.

For the four-wave mixing experiments, two s-polarized writing beams with equal intensity of 0.2 W/cm² in the sample were used; the spot diameter was 600 μm. A p-polarized beam of 1.7 mW/cm² counter propagating with respect to the writing beam nearest to the surface normal was used to probe the diffraction gratings; the spot diameter of the probe beam in the sample was 500 μm. The diffracted and the transmitted probe beam intensities were monitored to determine the diffraction efficiency. The diffraction efficiency was defined as

### Measurement 2: Rising Time (Response Time)

The diffraction efficiency was measured as a function of the applied field, using a procedure similar to that described in Measurement 1, by four-wave mixing experiments at 488 nm, or 532 nm, and 633 nm with s-polarized writing beams and a p-polarized probe beam. The angle between the bisector of the two writing beams and the sample normal was 60 degrees and the angle between the writing beams was adjusted to provide a 2.5 μm grating spacing in the material (˜20 degree). The writing beams had equal optical powers of 0.45 mW/cm², leading to a total optical power of 1.5 mW on the polymer, after correction for reflection losses. The beams were collimated to a spot size of approximately 500 μm. The optical power of the probe was 100 μW. The measurement of the grating buildup time was performed as follows: an electric field (V/μm) was applied to the sample, and the sample was illuminated with two writing beams and the probe beam. Then, the evolution of the diffracted beam was recorded. The rising time, or response time, was estimated as the time required to reach e⁻¹ of steady-state diffraction efficiency.

### Measurement 3: Transmittance

For measurements, a photorefractive layer was irradiated with a laser beam having an incident path perpendicular to the layer surface. The thickness of the composition was 100 μm. The beam intensity before and after passing through the photorefractive layer is monitored and the linear transmittance of the sample is given by:

$$T = {I}_{Transmitted} / {I}_{incident}$$

TABLE 1
Obtained Performance for Example 1

| Example 1 | at 488 nm | at 532 nm | at 633 nm |
|---|---|---|---|
| Initial diffraction | 39% | 38% | 37% |
| efficiency: | | | |
| Response time: | 1.4 (s) at | 2.5 (s) at 80 V/μm | 0.8 (s) at 80 V/μm |
| | 80 V/μm | | |
| Transmittance | 55% | 62% | 75% |

### Example 2

### Preparation of Photorefractive Composition

A photorefractive composition testing sample was prepared in a similar manner as Example 1 except using different composition components. The components of the composition for Example 2 were as follows:

| | | |
|---|---|---|
| (i) TPD charge transport (described in Production Example 2): | 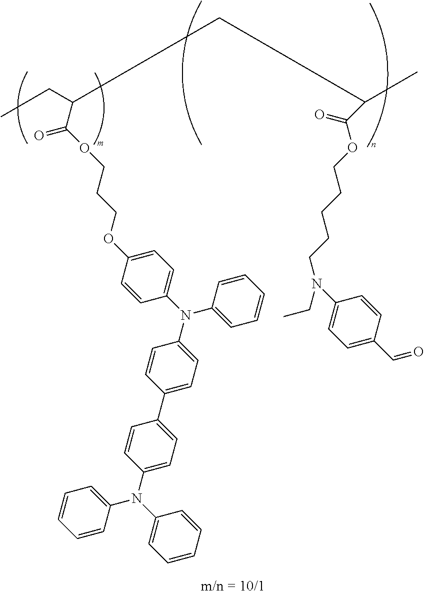 | 49.80 wt % |
| (ii) Prepared chromophore of methyl 3-(4-(azepan-1- yl)phenyl)acrylate: | 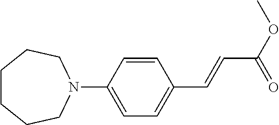 [SMILES: COC(=O)/C=C/c1ccc(N2CCCCCC2)cc1] | 29.88 wt % |
| (iii) 9-ethylcarbazole plasticizer: | 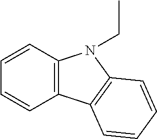 | 19.92 wt % |
| (iv) sensitizer PCBM | 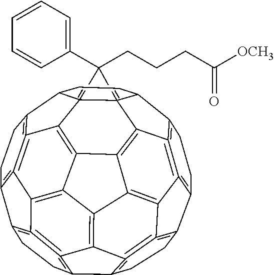 | 0.40 wt % |

TABLE 2
Obtained performance for Example 2

| Example 2 | at 488 nm | at 532 nm | at 633 nm |
|---|---|---|---|
| Initial diffraction | 42% | 56% | 44% |
| efficiency | | | |
| Response time: | 3.2 (s) at | 1.2 (s) at 80 V/μm | 5.2 (s) at 80 V/μm |
| | 80 V/μm | | |
| Transmittance | 50% | 51% | 65% |

### Example 3

### Preparation of Photorefractive Composition

A photorefractive composition testing sample was prepared in a similar manner as Example 1 except using different composition components. The components of the composition for Example 3 were as follows:

| | | |
|---|---|---|
| (i) TPD charge transport (described in Production Example 2): | 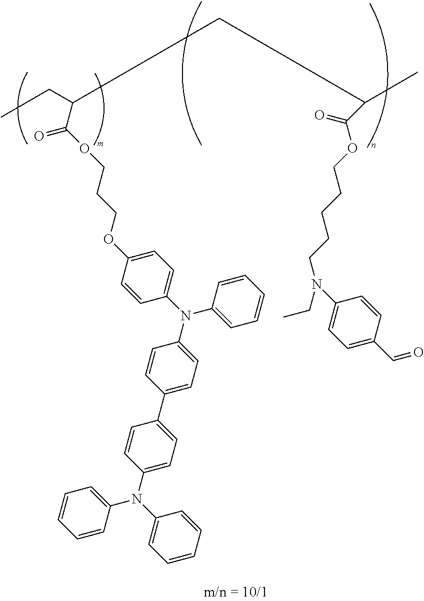 | 49.90 wt % |
| (ii) Prepared chromophore of methyl 3-(4-(azepan-1- yl)phenyl)acrylate: | 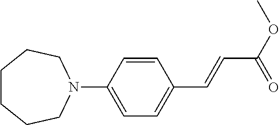 [SMILES: COC(=O)/C=C/c1ccc(N2CCCCCC2)cc1] | 29.94 wt % |
| (iii) 9-ethylcarbazole plasticizer: | 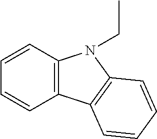 | 19.96 wt % |
| (iv) sensitizer C₇₀ derivative: | 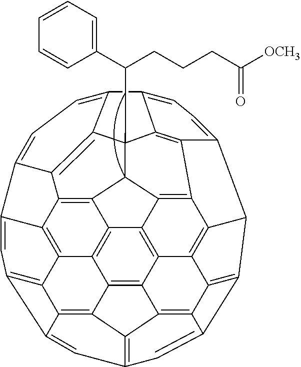 [SMILES: COC(=O)CCCC(C)(c1ccccc1)C12c3c4ccc5c3-c3c6c7c8c(c9cc%10cc%11c%12cc%13c%14ccc-4c1c%14c1c4c%14c(c3C42)c7c2c(c98)c%10c3c%11c%12c(c%131)c%14c32)C56] | 0.20 wt % |

TABLE 3
Obtained performance for Example 3

| Example 3 | at 488 nm | at 532 nm | at 633 nm |
|---|---|---|---|
| Initial diffraction | 41% | 37% | 25% |
| efficiency | | | |
| Response time: | 1 (s) at 80 V/μm | 3.2 (s) at | 4 (s) at 80 V/μm |
| | | 80 V/μm | |
| Transmittance | 22% | 35% | 64% |

In an embodiment, the photorefractive composition comprises four or more different components, including, for example, the host polymer (which can act as a charge-transport polymer), a plasticizer (which can reduce the glass transition temperature (Tg) of the composition and also impart phase stability to the resulting composition), a sensitizer which can aid in the absorption of the incident laser light, generating charge, and the nonlinear or electro-optic chromophore which can contribute to the refractive index modulation which in turn translates into the light intensity modulation creating the gratings. In an embodiment, the photorefractive composition includes about 49.9% of the host polymer, about 20% of the plasticizer, about 0.1% of the sensitizer, and about 30% of the nonlinear chromophore.

In an embodiment, photorefractive device fabrication involves two steps. The first step involves chunk preparation wherein the components described herein are mixed along with a solvent in a glass container and stirred until all the contents of the vial are dissolved completely. The contents of the vial are then transferred to a preheated glass plate at 55° C. and the solvent is allowed to evaporate completely leaving a solid chunk. The resulting chunk is then melted by placing it on a preheated (150° C.) conductive oxide coated glass (substrate) slide. Glass bead spacers of known thickness are placed on the substrate and a second substrate is placed over the chunk containing substrate and pressed well to complete the PR device fabrication.

Four-wave mixing experiments are performed on the devices wherein two laser beams with the same wavelength are combined in the sample at an angle to generate the diffraction gratings and a third laser beam is introduced from the opposite direction to the earlier two beams. The signal beam arising from the diffraction of the third beam at the grating formed through the interference of the first two laser beams is collected on the photodetector.

Embodiments of the invention described here have the advantage of a fast rise time which is defined as the time required for the diffraction signal or efficiency to reach 1/e of the overall diffraction signal or the efficiency achieved. The rise time determines how quickly the gratings are formed or how quickly the information or image can be stored in a photorefractive device. For example, in order to record images or write images at video rate the rise time needs to be as low as 30 ms.

The embodiments presented herein show very good phase stability even after several months. Embodiments of the compositions described herein retain good photorefractive properties, as the compositions are very stable and exhibit little or no phase separation. The phase stability in the compositions can be attributed to the good miscibility of the chromophores with the sensitizer and the polymer.

The following components were used in the Examples below:

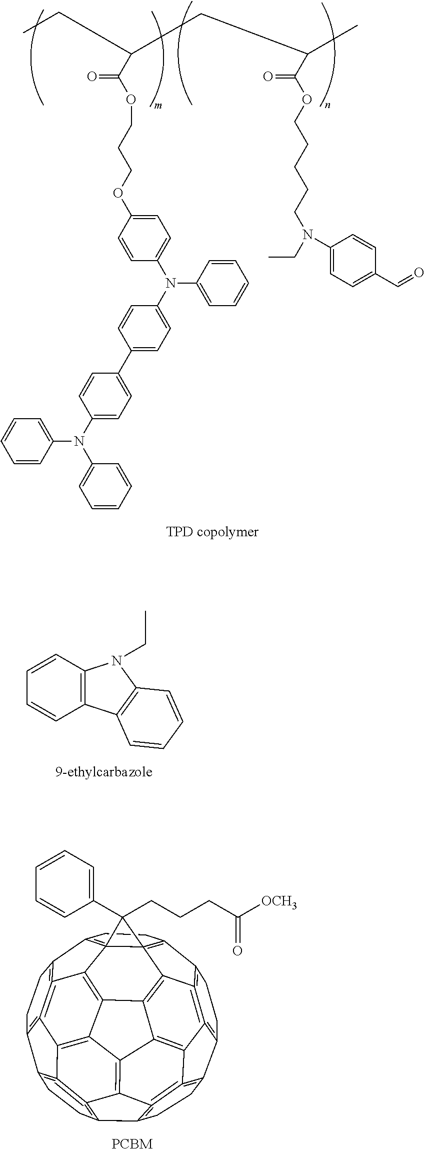

PCBM is {6}-1-(3-(methoxycarbonyl)propyl)-{5}-1-phenyl-[6,6]-C61.

### Example 4

A photorefractive composition comprising 49.9% of a TPD copolymer, 30% of the PR chromophore 4-(azepan-1-yl)phthalonitrile as shown below, 20% of 9-ethylcarbazole and 0.1% of {6}-1-(3-(methoxycarbonyl)propyl)-{5}-1-phenyl-[6,6]-C61 commonly known as {C61}-PCBM were mixed in dichloromethane.

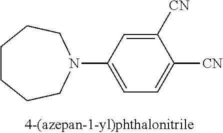 [SMILES: N#Cc1ccc(N2CCCCCC2)cc1C#N]

To prepare the photorefractive composition, the components listed above were dissolved in dichloromethane with stirring and then dripped onto glass plates at 55° C. using a glass syringe fitted with a 0.2 μm PTFE filter at 55° C. for five minutes and then held under vacuum for five minutes. The composites were then heated at 150° C. for five minutes and then subjected to vacuum for 30 seconds. The composites were then scrapped and cut into chunks.

The response time and transmittance were measured using a blue laser in accordance with the procedures outlined in Example 1. The obtained performance was as follows:

| Example 4 | at 488 nm | at 457 nm |
|---|---|---|
| Response time: | 0.050 (s) at 70 V/μm | 0.048 (s) at 70 V/μm |
| Transmittance | 57% | 56% |

### Example 5

Example 5 was performed in the same manner as in Example 4 except that the following materials were used: a photorefractive composition comprising 49.9% of a TPD copolymer, 40% of the PR chromophore 4-(azepan-1-yl)phthalonitrile as shown above and 15% of 9-ethylcarbazole and 0.1% of {6}-1-(3-(methoxycarbonyl)propyl)-{5}-1-phenyl-[6,6]-C61 commonly known as {C61}-PCBM.

| Example 5 | at 488 nm |
|---|---|
| Response time: | 0.036 (s) at 70 V/μm |
| Transmittance | 56% |

### Example 6

Example 6 was performed in the same manner as in Example 4 except that the following materials were used: a photorefractive composition comprising 49.9% of a TPD copolymer, 45% of the PR chromophore 4-(azepan-1-yl)phthalonitrile as shown above and 5% of 9-ethylcarbazole and 0.1% of {6}-1-(3-(methoxycarbonyl)propyl)-{5}-1-phenyl-[6,6]-C61 commonly known as {C61}-PCBM.

| Example 6 | at 488 nm |
|---|---|
| Response time: | 0.020 (s) at 70 V/μm |
| Transmittance | 56% |

### Example 7

Example 7 was performed in the same manner as in Example 4 except that the following materials were used: a photorefractive composition comprising 49.9% of a TPD copolymer, 50% of the PR chromophore 4-(azepan-1-yl)phthalonitrile as shown above and 0% of 9-ethylcarbazole and 0.1% of {6}-1-(3-(methoxycarbonyl)propyl)-{5}-1-phenyl-[6,6]-C61 commonly known as {C61}-PCBM.

| Example 7 | at 488 nm |
|---|---|
| Response time: | 0.032 (s) at 70 V/μm |
| Transmittance | 54% |

### Example 8

Example 8 was performed in the same manner as in Example 4 except that the following materials were used: a photorefractive composition comprising 49.9% of a TPD copolymer, 30% of the PR chromophore 1-(3-methyl-4-nitrophenyl)azepane as shown below and 20% of 9-ethylcarbazole and 0.1% of {6}-1-(3-(methoxycarbonyl)propyl)-{5}-1-phenyl-[6,6]-C61 commonly known as {C61}-PCBM.

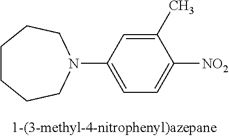 [SMILES: Cc1cc(N2CCCCCC2)ccc1[N+](=O)[O-]]

| Example 8 | at 488 nm |
|---|---|
| Response time: | 0.046 (s) at 70 V/μm |
| Transmittance | 44% |

### Example 9

Example 9 was performed in the same manner as in Example 4 except that the following materials were used: a photorefractive composition comprising 49.9% of a TPD copolymer, 30% of the PR chromophore 1,2,3,5,6,7-hexahydropyrido[3,2,1-ij]quinoline-9-carbonitrile as shown below, 20% of 9-ethylcarbazole and 0.1% of {6}-143-(methoxycarbonyl)propyl)-{5}-1-phenyl-[6,6]-C61 commonly known as {C61}-PCBM.

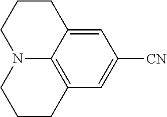 [SMILES: N#Cc1cc2c3c(c1)CCCN3CCC2]

| Example 9 | at 488 nm |
|---|---|
| Response time: | 0.160 (s) at 70 V/μm |
| Transmittance | 67% |

### Example 10

Example 10 was performed in the same manner as in Example 4 except that the following materials were used: a photorefractive composition comprising 49.9% of a DiCN-TPD copolymer as shown below, 30% of the PR chromophore 1,2,3,5,6,7-hexahydropyrido[3,2,1-ij]quinoline-9-carbaldehyde as shown below, 20% of 9-ethylcarbazole and 0.1% of {6}-1-(3-(methoxycarbonyl)propyl)-{5}-1-phenyl-[6,6]-C61 commonly known as {C61}-PCBM.

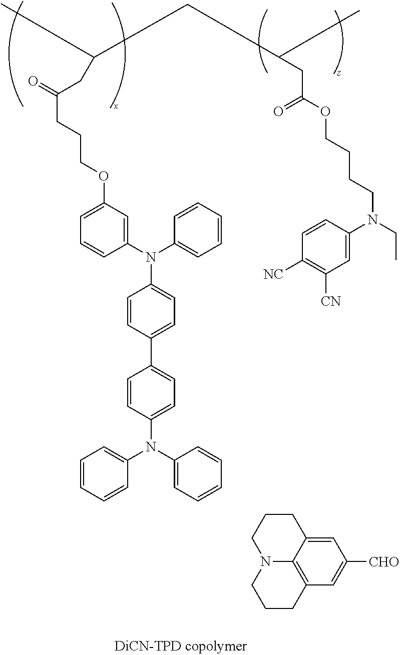

| Example 10 | at 488 nm |
|---|---|
| Response time: | 0.136 (s) at 70 V/μm |
| Transmittance | 57% |

### Example 11

Example 11 was performed in the same manner as in Example 4 except that the following materials were used: a photorefractive composition comprising 49.9% of a DiCN-TPD copolymer as shown above, 30% of the PR chromophore 3-(azepan-1-yl)phthalonitrile as shown below and 20% of 9-ethylcarbazole and 0.1% of {6}-143-(methoxycarbonyl)propyl)-{5}-1-phenyl-[6,6]-C61 commonly known as {C61}-PCB M.

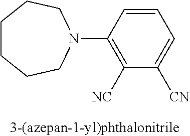 [SMILES: N#Cc1cccc(N2CCCCCC2)c1C#N]

| Example 11 | at 488 nm |
|---|---|
| Response time: | 0.080 (s) at 70 V/μm |
| Transmittance | 60% |

### Example 12

A photorefractive composition was obtained in the same manner as in the Example 1 except using different composition components. No sensitizer was in the composition. The components of the composition were as follows:

| | | |
|---|---|---|
| (i) TPD charge transport (described in Production Example 2): | 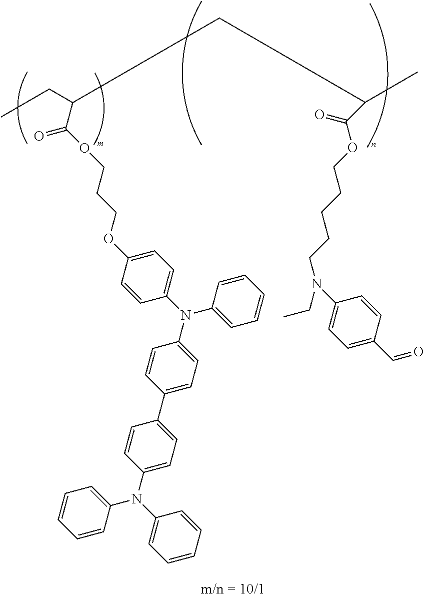 | 50.0 wt % |
| (ii) Prepared chromophore of methyl 3-(4-(azepan-1- yl)phenyl)acrylate: | 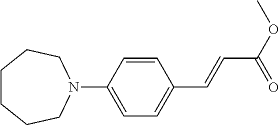 [SMILES: COC(=O)/C=C/c1ccc(N2CCCCCC2)cc1] | 30.0 wt % |
| (iii) 9-ethylcarbazole plasticizer: | 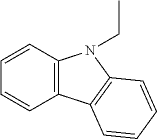 | 20.0 wt % |

TABLE 4
Obtained performance for Example 12

| Example 12 | at 488 nm | at 532 nm | at 633 nm |
|---|---|---|---|
| Initial diffraction | 50% | 24% | No signal |
| efficiency | | | |
| Response time: | 12 (s) at 70 V/μm | 3.8 (s) at 70 V/μm | N/A |
| Transmittance | 73% | 84% | 87% |

As shown in Example 12, diffraction efficiency was observed at 488 nm and 532 nm. No grating formation ability was observed at 633 nm laser beam. The composition exhibited transmittance at all three wavelengths, with the highest transmittance in the red laser wavelength.

### Example 13

A photorefractive composition testing sample was prepared in a similar manner as Example 1 except using different composition components. The components of the composition for Example 13 were as follows:

| | | |
|---|---|---|
| (i) TPD charge transport (described in Production Example 2): | 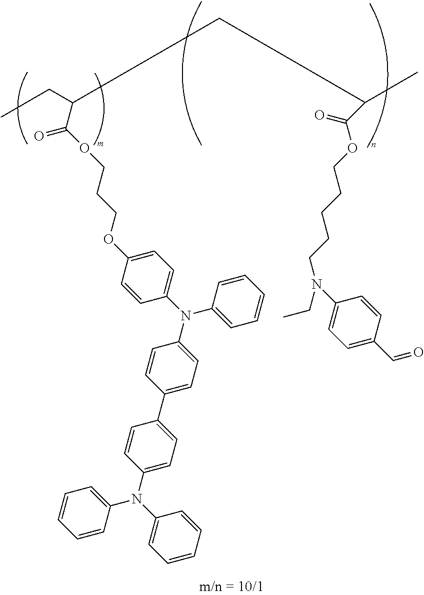 | 49.90 wt % |
| (ii) Prepared chromophore of 4- (azepan-1-yl) benzonitrile: | 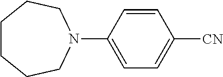 [SMILES: N#Cc1ccc(N2CCCCCC2)cc1] | 29.94 wt % |
| (iii) 9-ethylcarbazole plasticizer: | 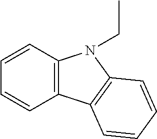 | 19.96 wt % |
| (iv) PCBM sensitizer: | 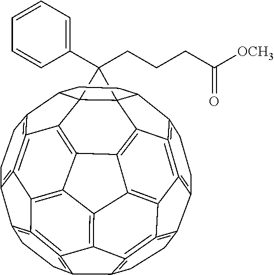 | 0.20 wt % |

TABLE 5
Obtained performance for Example 13

| Example 13 | at 488 nm | at 532 nm | at 633 nm |
|---|---|---|---|
| Initial | 21% | 22% | 18% |
| diffraction | | | |
| efficiency | | | |
| Response time: | 25 (s) at 70 V/μm | 27 (s) at 70 V/μm | 56 (s) at 70 V/μm |
| Transmittance | 62% | 64% | 75% |

As shown in Example 13, diffraction efficiency was observed at 488 nm, 532 nm, and 633 nm laser beam. The composition (containing PCBM) exhibited transmittance at all three wavelengths, with the highest transmittance in the red laser wavelength.

### Example 14

A photorefractive composition was obtained in the same manner as in the Example 13 except no sensitizer was present. The components of the composition were as follows:

| | | |
|---|---|---|
| (i) TPD charge transport (described in Production Example 2): | 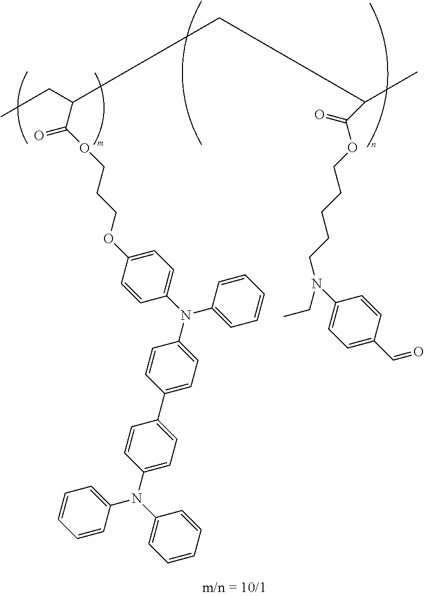 | 50.0 wt % |
| (ii) Prepared chromophore of 4-(azepan-1- yl)benzonitrile: | 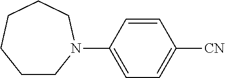 [SMILES: N#Cc1ccc(N2CCCCCC2)cc1] | 30.0 wt % |
| (iii) 9-ethylcarbazole plasticizer: | 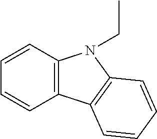 | 20.0 wt % |

TABLE 6
Obtained performance for Example 14

| Example 14 | at 488 nm | at 532 nm | at 633 nm |
|---|---|---|---|
| Initial diffraction efficiency | <0.2% | No signal | No signal |
| Response time: | N/A | N/A | N/A |
| Transmittance | 86% | 86% | 88% |

As shown in Example 14, the composition exhibited transmittance at all three wavelengths of light. Weak diffraction efficiency was observed when irradiated by 488 nm laser beam. As shown in Example 13, initial diffraction efficiency can be increased by the presence of sensitizer.

### Comparative Example 1

A photorefractive composition was obtained in the same manner as in the Example 1 except using different composition components. The components of the composition were as follows:

| | | |
|---|---|---|
| (i) TPD charge transport (described in Production Example 2): | 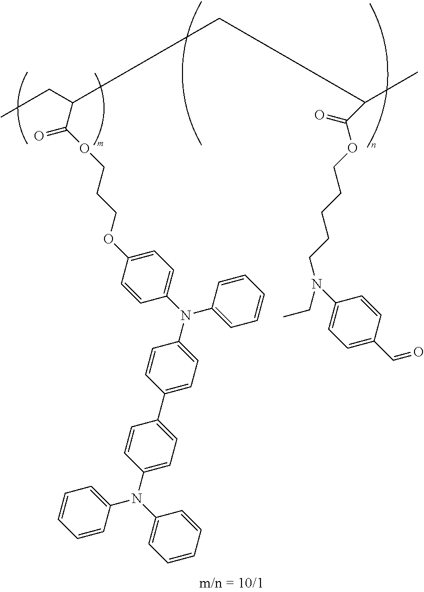 | 50.0 wt % |
| (ii) Prepared chromophore of 7- FDCST: | 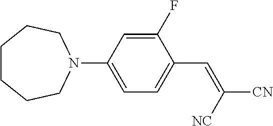 [SMILES: N#CC(C#N)=Cc1ccc(N2CCCCCC2)cc1F] | 30.0 wt % |
| (iii) 9-ethylcarbazole plasticizer: | 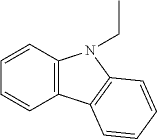 | 20.0 wt % |

TABLE 7
Obtained performance for Comparative Example 1

| Comparative Example 1 | at 488 nm | at 532 nm | at 633 nm |
|---|---|---|---|
| Initial diffraction efficiency | No signal | 80% | <1% |
| Response time: | No signal | 30 (ms) at | 0.26 (s) at |
| | | 55 V/um | 60 V/μm |
| Transmittance | Less than 1% | 34% | 88% |

As shown in this comparative example, which is a composition known from the prior art, no grating formation ability was observed using the 488 nm laser beam. While good diffraction efficiency was observed when irradiated by 532 nm green laser beam, the composition did not show good properties at all three wavelengths of laser light, as compared to Examples 1-3 above.

### Comparative Example 2

Comparative Example 2 was performed in the same manner as in Example 4 except that the following materials were used: a photorefractive composition comprising 49.9% of a DiCN-TPD copolymer as shown above, 30% of the PR chromophore 244-(azepan-1-yl)-2-fluorobenzylidene)malononitrile as shown below and 20% of 9-ethylcarbazole.

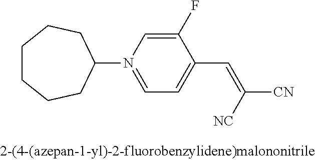

| Comparative Example 2 | At 488 nm |
|---|---|
| Response time: | No signal |
| Transmittance | 1% |

As shown in this comparative data which is described in the prior art, no grating formation ability was observed because the composition is too dark for the 488 nm laser beam.

All literature references and patents mentioned herein are hereby incorporated in their entireties. Although the foregoing invention has been described in terms of certain preferred embodiments, other embodiments will become apparent to those of ordinary skill in the art in view of the disclosure herein without departing from the scope of the invention. Accordingly, all such modifications and changes are intended to fall within the scope of the invention, as defined by the appended claims.

1. A composition comprising a polymer and a chromophore, wherein the polymer comprises a repeating unit that includes at least one moiety selected from the group consisting of the following formulae (Ia), (Ib) and (Ic): 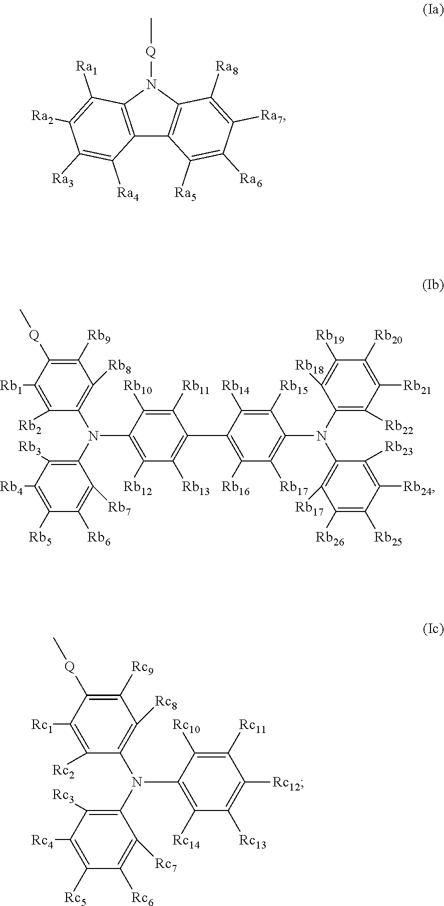
wherein each Q in formulae (Ia), (Ib) and (Ic) independently represents an alkylene group having from 1 to 10 carbon atoms or a heteroalkylene group having from 1 to 10 carbon atoms, Ra₁-Ra₈, Rb₁-Rb₂₇ and Rc₁-Rc₁₄ in formulae (Ia), (Ib), and (Ic) are each independently selected from the group consisting of hydrogen, C₁-C₁₀ alkyl, and C₄-C₁₀ aryl, wherein the C₁-C₁₀ alkyl may be linear or branched,
wherein the chromophore comprises a structure of the formulae (III), (IV), (V), (VI), (VII), or (VIII): 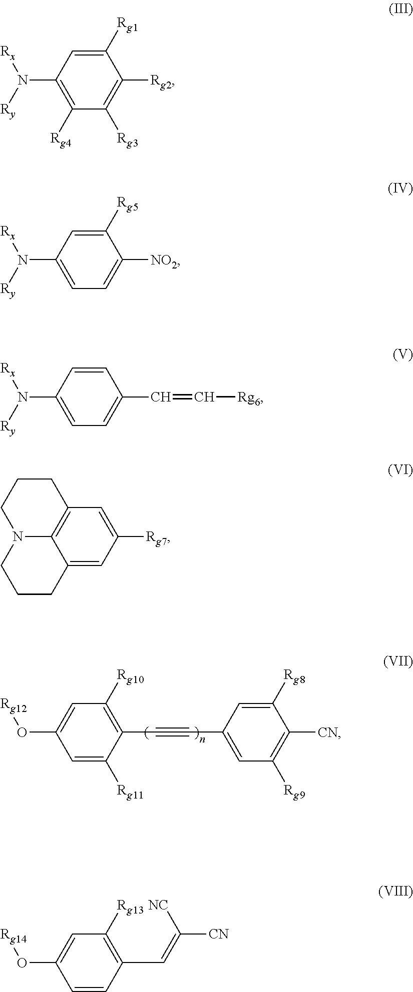
wherein Rₓ and R_{y} in formula (III) together with the nitrogen to which they are attached form a cyclic C₄-C₉ ring or Rₓ and R_{y} in formula (III) are each independently selected from a C₁-C₆ alkyl group or a C₄-C₁₀ aryl group, wherein R_{g1}-R_{g4} in formula (III) are each independently selected from hydrogen or CN, and at least one of R_{g1}-R_{g4} in formula (III) are CN;
wherein Rₓ and R_{y} in formula (IV) together with the nitrogen to which they are attached form a cyclic C₄-C₉ ring or Rₓ and R_{y} in formula (IV) are each independently selected from a C₁-C₆ alkyl group or a C₄-C₁₀ aryl group, and R_{g5} in formula (IV) is C₁-C₆ alkyl;
wherein Rₓ and R_{y} in formula (V) together with the nitrogen to which they are attached form a cyclic C₄-C₉ ring or Rₓ and R_{y} in formula (V) are each independently selected from a C₁-C₆ alkyl group or a C₄-C₁₀ aryl group, R_{g6} in formula (V) is selected from CN or COOR, wherein R in formula (V) is hydrogen or a C₁-C₆ alkyl;
wherein R_{g7} in formula (VI) is selected from CN, CHO, or COOR, wherein R in formula (VI) is hydrogen or a C₁-C₆ alkyl;
wherein n in formula (VII) is 0 or 1, R_{g8} and R_{g9} in formula (VII) are each independently selected from hydrogen, fluorine or CN, R_{g10} and R_{g1i} in formula (VII) are each independently selected from hydrogen, methyl, methoxy, or fluorine, R_{g12} in formula (VII) is a C₁-C₁₀ oxyalkylene group containing 1 to 5 oxygen atoms or a C₁-C₁₀ alkyl group, and at least two of R_{g8}-R_{g12} in formula (VII) are not hydrogen;
wherein R_{g13} in formula (VIII) is selected from hydrogen or fluorine, and R_{g14} in formula (VIII) is a C₁-C₆ alkyl or a C₁-C₁₀ oxyalkylene group containing 1 to 5 oxygen atoms.

2. The composition of claim 1, further comprising a sensitizer.

3. The composition of claim 1, wherein the polymer further comprises a second repeating unit that includes a moiety represented by the following formula (IIa): 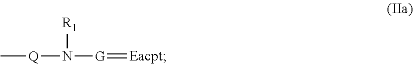
wherein Q in formula (IIa), independently of Q in formulae (Ia), (Ib), and (Ic), represents an alkylene group having from 1 to 10 carbon atoms or a heteroalkylene group having from 1 to 10 carbon atoms; R₁ in formula (IIa) is selected from the group consisting of hydrogen, linear C₁-C₁₀ alkyl, branched C₁-C₁₀ alkyl and C₄-C₁₀ aryl; G in formula (IIa) is a π-conjugated group; and Eacpt in formula (IIa) is an electron acceptor group.

4. The composition of claim 2, wherein the sensitizer comprises a fullerene.

5. The composition of claim 4, wherein the fullerene is selected from the group consisting of optionally substituted C₆₀, optionally substituted C₇₀, optionally substituted C₈₄, optionally substituted single-wall carbon nanotube, and optionally substituted multi-wall carbon nanotube.

6. The composition of claim 5, wherein the fullerene is selected from the group consisting of [6,6]-phenyl-C₆₁-butyricacid-methylester, [6,6]-phenyl-C₇₁-butyricacid-methylester, and [6,6]-phenyl-C₈₅-butyricacid-methylester.

7. The composition of claim 2, wherein the sensitizer is selected from the group consisting of optionally substituted phthalocyanine, optionally substituted perylene, optionally substituted porphyrin, and optionally substituted terrylene.

8. The composition of claim 1, further comprising a combination of sensitizers, wherein the combination of sensitizers is selected from the group consisting of optionally substituted fullerenes, optionally substituted phthalocyanines, optionally substituted perylenes, optionally substituted porphyrins, and optionally substituted terrylenes.

9. The composition of claim 2, wherein the composition comprises the sensitizer in an amount in the range of about 0.01% to about 5%, by weight based on the total weight of the composition.

10. The composition of claim 1, wherein the composition further comprises a plasticizer.

11. The composition of claim 10, wherein the plasticizer is selected from N-alkyl carbazole derivatives and triphenylamine derivatives.

12. The composition of claim 1, wherein the composition is configured to be photorefractive upon irradiation by at least a first laser having a first wavelength in the visible light spectrum and a second laser having a second wavelength in the visible light spectrum, wherein the first wavelength is different from the second wavelength and wherein the first and second lasers are selected from a blue laser, a green laser, and a red laser.

13. The composition of claim 1, wherein the composition has a transmittance of higher than about 30% at a thickness of 100 μm when irradiated by two or more of a blue laser, a green laser, and a red laser.

14. The composition of claim 12, wherein the composition has a diffraction efficiency of about 25% or greater upon irradiation with the first laser and the second laser.

15. The composition of claim 12 to 111, wherein the composition is photorefractive upon irradiation with a third laser having a third wavelength in the visible light spectrum, such that the third laser has a wavelength that is different from that of the first laser and the second laser, wherein the third laser is selected from a blue laser, a green laser, and a red laser, and wherein the composition has a diffraction efficiency of about 25% or greater upon irradiation with the first, second, and third laser.

16. The composition of claim 12, wherein the blue laser has a wavelength of about 488 nm, the green laser has a wavelength of about 532 nm, and the red laser has a wavelength of about 633 nm.

17. The composition of claim 12, wherein the blue laser has a wavelength of about 457 nm, the green laser has a wavelength of about 532 nm, and the red laser has a wavelength of about 633 nm.

18. An optical device that comprises the composition of claim 1.

19. A method for modulating light, comprising the steps of:
providing a photorefractive composition that comprises a polymer and a chromophore, wherein the polymer comprises a repeating unit that includes a moiety selected from the group consisting of the following formulae (Ia), (Ib) and (Ic): 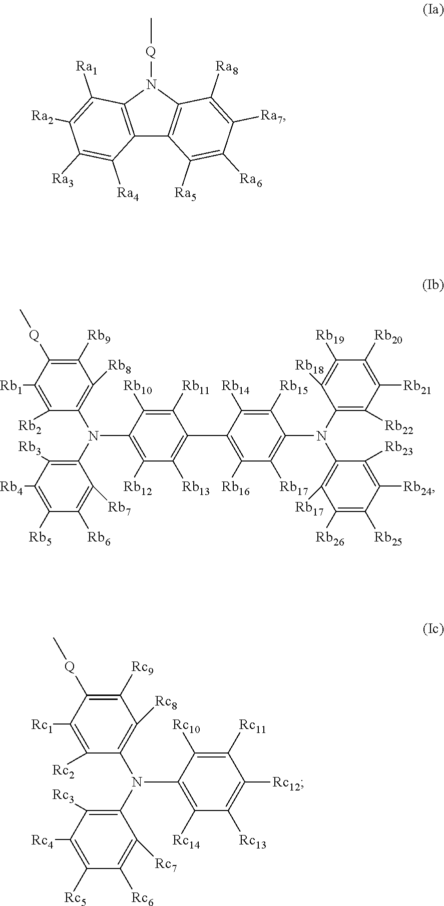
wherein each Q in formulae (Ia), (Ib) and (Ic) independently represents an alkylene group having from 1 to 10 carbon atoms or a heteroalkylene group having from 1 to 10 carbon atoms, Ra₁-Ra₈, Rb₁-Rb₂₇ and Rc₁-Rc₁₄ in (Ia), (Ib), and (Ic) are each independently selected from the group consisting of hydrogen, C₁-C₁₀ alkyl, and C₄-C₁₀ aryl, wherein the C₁-C₁₀ alkyl may be linear or branched;
wherein the polymer and the chromophore are together selected to configure the composition to be photorefractive upon irradiation by both a first laser and a second laser, wherein the first laser has a wavelength that is different from the wavelength of the second laser, and wherein the first and second lasers are selected from a blue laser, a green laser, and a red laser; and
irradiating the photorefractive composition with two or more of a blue laser, a green laser and a red laser to thereby modulate a photorefractive property of the composition.

20. A method for modulating light, comprising the steps of:
providing a composition of claim 1; and
irradiating the composition with two or more of a blue laser, a green laser and a red laser to thereby modulate a photorefractive property of the composition.
